(19) United States
(12) Patent Application Publication
(10) Pub. No.: US 2026/0115899 A1
(43) Pub. Date: Apr. 30, 2026

(54) Layered Low-Profile Soft Fluidic Actuator Device And Method

(71) Applicants: Run Ze GAO, Kitchener, Ontario (CA); Peter Seungjune LEE, Waterloo, Ontario (CA); Carolyn Liqing REN, Waterloo, Ontario (CA)

(72) Inventors: Run Ze GAO, Kitchener, Ontario (CA); Peter Seungjune LEE, Waterloo, Ontario (CA); Carolyn Liqing REN, Waterloo, Ontario (CA)

(21) Appl. No.: 19/120,570

(22) PCT Filed: Oct. 13, 2023
(86) PCT No.: PCT/CA2023/051363

§ 371 Date: Apr. 11, 2025

Related U.S. Application Data
(60) Provisional application No. 63/416,507, filed on Oct. 15, 2022.

(51) Int. Cl. B25J 9/14; F15B 15/10

(52) U.S. Cl. CPC B25J 9/142; F15B 15/103

(57) ABSTRACT

Layered low-profile soft fluidic actuators (LLPSFA) enhance the functionality of soft robots and devices/systems with soft robotic components. A plurality of LLPSFA enables soft robotic devices and systems to achieve a variety of motion, movement, torques, forces, and/or dexterity, which may have in part and/or complete anthropomorphism. LLPSFA may fit into tight spaces and have higher efficiency than other soft robotic actuators. LLPSFA can operate by means of positive fluidic pressurization, negative fluidic depressurization, or vacuum. LLPSFA enables linear motion and/or angular motion. LLPSFA may also be used as a sensor to detect or measure linear motion and/or angular motion. LLPSFA may operate as a sensor and actuator simultaneously. Additional components including but not limited to backing structures, attachment mechanisms, fluidic conduits, spring-damper mechanisms, and protective elements along with functional modules work synergistically with LLPSFA to achieve continuum robotics for finite degree of freedom by means of a hybrid system.

### FIELD OF THE INVENTION

The present invention generally relates to the field of robotics, and more specifically to soft robotics. Even more specifically, the present invention uses layered low-profile soft fluidic actuators to enable soft robotic devices and systems. Even more specifically, the present invention uses one or a plurality of layered low-profile soft fluidic actuators to enable soft robotic devices and systems to achieve a variety of motion, movement, torques, forces, and/or dexterity, which may have in part and/or complete anthropomorphism.

### BACKGROUND OF THE INVENTION

Fluidic actuators in the form of hydraulic and pneumatic linear actuators have long been used in robotic, manufacturing, and automation systems. The formation of these linear actuators is simple, a piston inside a hollow cylinder where pressurized fluid is pumped into the cylinder to push on the piston, thus converting fluidic energy into mechanical linear motion, force, and/or power based on the working principles of fluid dynamics and pressure. Pneumatics may achieve fast motion, whereas hydraulics, as an incompressible liquid, offers an instantaneous response, precise motion, and often higher force than pneumatics. These systems usually consist of a variety of fluidic components, including but not limited to fluidic compressors, fluidic pumps, accumulators, pressure reservoirs, transition lines, air tanks, hoses, standard cylinders, and automated solenoid valves. When hydraulic and pneumatic linear actuators are combined with other mechanical systems, including but not limited to linkages and sliding arms, bending and rotating motions may be created. However, these systems are often bulky, heavy, expensive and complex.

Pneumatic artificial muscle, such as the Mckibben artificial muscle, one of the most well-known, was first introduced in the 1950s by Joseph L. Mckibben for use in prosthetic limbs. It is a hollow soft braided tubular bladder that shortens. The advantage of Mckibben artificial muscles is that it can generate large forces and has a high power density; hence, it has an excellent power-to-weight ratio, and it is simple and inexpensive to manufacture. A feedback PI or PID controller is sufficient to control Mckibben artificial muscles. Similar to hydraulic and pneumatic linear actuators, it requires additional mechanical systems in order to create bending and rotating motions. Variations of Mckibben artificial muscles have been created utilizing smart materials, including but not limited to shape memory alloys and/or utilizing different shapes and constructions.

Monolithic soft fluidic actuators, meaning a single continuous actuator for bending and creating motion, gained much traction beginning in the early 2010s due to their inherent compliance and non-threatening nature of soft matter, allowing them to work with and help humans synergistically. Thus, soft fluidic actuators became the most important component for robots that interact with humans and are named soft robots accordingly. Pneumatic network soft fluidic actuators, fiber-reinforced soft fluidic actuators, textile and/or strain-limiting soft fluidic actuators became and continue to be impactful for soft robotics, in particular, soft wearable assistive robots, but lacking of rigid and/or semi-rigid structures hinders their usage in high torque, bending, and/or soft robots having anthropomorphic manipulation and/or requiring precision and accuracy with a low-profile form factor.

Recently, a new set of bellow and/or accordion-shaped soft fluidic actuators emerged and is poised to compete with monolithic soft fluidic actuators for both bending and linear motion. However, they are often bulky, with a thick wall requiring a large amount of pressurization to achieve any meaningful torque and/or force. In addition, they have often been used for large components and have been difficult to miniaturize and/or achieve multi-degree-of-freedom motion such as combining linear motion with bending motion.

### DESCRIPTION OF PRIOR ART

Patent reference U.S. Pat. No. 10,562,180B2 may disclose a fluidic robotic actuator system integrated with rigid backing structure for attaining linear and/or angular movements, as well as applications as robotic manipulator.

Research journal article titled “A New Class of Flexible Fluidic Actuators and their Applications in Medical Engineering” (DOI: https://doi.org/10.1524/auto.1999.47.8.390) by Schulz et al. may disclose a concept and mathematical formation of a joint structure constructed with the use of flexible fluidic actuators.

Research journal article titled “A New Ultralight Anthropomorphic Hand” (DOI: https://doi.org/10.1109/ICHR.2008.4755987) by Gaiser et al. may disclose a pneumatically controlled anthropomorphic robotic hand constructed with reinforced flexible fluidic actuators and a rigid linkage structure to deliver angular displacement and torque about a common center of rotation.

Research journal article titled “Design of a Modular Arm Robot System based on Flexible Fluidic Drive Elements” (DOI: https://doi.org/10.1109/ICORR.2007.4428437) by Kargov et al. may disclose fluidically-driven joint modules structured with rigid links and revolute joint which is driven by two flexible fluidic actuators with each capable of rotating 180 degrees.

Research journal article titled “Euglenoid-Inspired Giant Shape Change for Highly Deformable Soft Robots” (DOI: https://doi.org/10.1109/LRA.2017.2726113) by Digumarti et al. may disclose a bioinspired biomimetic soft pneumatic actuator capable of achieving a large volumetric displacement.

Research journal article titled “Design, Modeling, and Control of a Soft Robotic Arm” (DOI: https://doi.org/10.1109/IROS.2018.8594221) by Hofer et al. may disclose a hybrid robotic arm consisting of two soft inflatable actuators, a rigid one degree of freedom joint and a rigid link.

Research journal article titled “A Layered Manufacturing Approach for Soft and Soft-Rigid Hybrid Robots” (DOI: https://doi.org/10.1089/soro.2018.0093) by Yang et al. may disclose a manufacturing process for creating multichambered inflatable robots fabricated using fabrics, textiles, plastics, thermoplastic polyurethane, or other materials. These robots include structures that can include soft components such as soft actuators and rigid components such as rigid linkages. The utilization of fabric and/or plastic makes their actuators inelastic and creates thicker walls, which are not low-profile when fully or nearly fully depressurized.

Research journal article titled “Mechanoreception for Soft Robots via Intuitive Body Cues” (DOI: https://doi.org/10.1089/soro.2018.0135) by Wang et al. may disclose a linearly translating pneumatic bellow actuator and its use case as mechanoreception scheme to enable proprioceptive movements and external contacts.

However, the prior art presented above may have suffered from one or more significant problems and/or shortcomings. For example, all of this prior art may have suffered from one or more problems including but not limited to the following: (a) lack of structural rigidity from relying only on soft robotic actuators without any rigid structures; (b) lack of compliance of the robots from relying only on rigid robotic structures (c) inability to fully retract the actuators to a minimal thickness; (d) large size/bulkiness/formfactor of the embodiments resulting inefficient and/or impractical wearable products; (e) requiring complex fabrication techniques involving advanced and/or expensive equipment, and/or (f) inefficient power input to movement output ratio.

Embodiments of the invention disclosed herein obviate or mitigate one or more disadvantages and/or shortcomings associated with the prior art, and/or meet or provide for one or more needs and/or advantages, and/or achieve one or more objects of the invention—one or more of which may preferably be readily appreciable by and/or suggested to those skilled in the art in view of the teachings and/or disclosures hereof.

### BRIEF SUMMARY OF THE INVENTION

Embodiments of the present disclosure provide layered low-profile soft fluidic actuators (LLPSFA) and associated subcomponents and/or modules which enable commercially viable systems and devices. Embodiments of the layered low-profile soft fluidic actuator device and method/or method that may find advantageous utility in association with applications including but not limited to the following: (i) entertainment, (ii) medical devices, (iii) assistive devices, (iv) robotics, (v) humanoid robotics, (vi) fruit and vegetable handling and harvesting, (vii) object handling, (viii) education, (ix) exploration, (x) undersea exploration, (xi) space exploration, (xii) mimicking motions and movements of an organism, (xiii) sex toys, (xiv) haptics, (xv) augmented and/or virtual reality, (xvi) surgical equipment and/or tools, (xvii) bionics, and, (xviii) prostheses.

According to the invention, embodiments utilizing continuum robotics for finite degree of freedom by means of hybrid system are presented.

According to an aspect of a preferred embodiment of the invention, layered low-profile soft fluidic actuators may be fully, nearly fully, deflated/depressurized and/or vacuumed to provide linear motion, force, angular motion, torque, or any combination thereof.

According to an aspect of a preferred embodiment of the invention, layered low-profile soft fluidic actuators may have minimal thickness and near zero volume when fully, nearly fully, deflated/depressurized and/or vacuumed.

According to an aspect of a preferred embodiment of the invention, layered low-profile soft fluidic actuators may be fully, nearly fully, inflated/pressurized to provide linear motion, force, angular motion, torque, or any combination thereof.

According to an aspect of a preferred embodiment of the invention, layered low-profile soft fluidic actuators may expand, curve, and/or stretch when fully, nearly fully, inflated/pressurized.

According to an aspect of a preferred embodiment of the invention, layered low-profile soft fluidic actuators may be constructed to have the internal chambers of one or more layers to be fluidly connected.

According to an aspect of a preferred embodiment of the invention, layered low-profile soft fluidic actuators may have walls made of materials exhibiting elastic and/or flexible properties and/or any combination thereof.

According to an aspect of a preferred embodiment of the invention, layered low-profile soft fluidic actuators may be comprised of homogenous material, combination of different materials, and/or composite materials.

According to an aspect of a preferred embodiment of the invention, layered low-profile soft fluidic actuators may be comprised of at least one or more expanding structure which may preferably be near-zero volume when deflated or vacuumed and expand, curve, and or stretch when pressurized, and at least one or more linkage structure which may preferable convert the linear motion of the expanding structure to bending and/or rotation motion about at least one axis of rotations.

According to an aspect of a preferred embodiment of the invention, layered low-profile soft fluidic actuators may have any number of layers as well as the surfaces available for integration with external components including but not limited to attachment mechanism, motion mechanism, fluidic conduit, spring-damper mechanism, protective element, and sensors.

According to an aspect of a preferred embodiment of the invention, layered low-profile soft fluidic actuators may have varying sizes of the expanding structure with varying sizes of the linkage structure.

According to an aspect of a preferred embodiment of the invention, layered low-profile soft fluidic actuators may have bonded ends and/or fluidic inlets of any shape, size, geometry, materials, and/or any combination thereof.

According to an aspect of a preferred embodiment of the invention, layered low-profile soft fluidic actuators may be attached to at least one or more external structures.

According to an aspect of a preferred embodiment of the invention, any layered low-profile soft fluidic actuators may be attached to at least two or more backing structures of any physical properties including but not limited to shape, size, function, make, weight, dimension, and/or volume, and/or may be comprised of any type of materials, components, and/or any combination thereof.

According to an aspect of a preferred embodiment of the invention, any number of layered low-profile soft fluidic actuators may be integrated with any number of motion mechanisms providing rotation about any number of common and/or uncommon centers of rotation.

According to an aspect of a preferred embodiment of the invention, the motion mechanisms provide preferably bending and/or rotation motion of the backing structures, but are not limited to providing attachment, connection, and/or mate of two or more backing structures.

According to an aspect of a preferred embodiment of the invention, any layered low-profile soft fluidic actuators may be integrated with multi-component protective element comprised of multiple shells of any materials, to protect from external forces and environments.

According to an aspect of a preferred embodiment of the invention, the multi-component protective element may or may not be hinged to common axis of rotation as the backing structure and/or the axes of layered low-profile soft fluidic actuators.

According to an aspect of a preferred embodiment of the invention, the multi-component protective element may be attached permanently and/or non-permanently to the backing structure in mechanical means and/or chemical means, and/or by any attachment mechanisms, and/or any combination thereof.

According to an aspect of a preferred embodiment of the invention, the multi-component protective element may or may not incorporate at least one full-span motion limiter to prevent the protective shells from rotating over the maximum rotational limit, and/or/with full-retraction motion limiters to prevent the protective shells from rotating over the limit of fully retracted position. Two or more motion limiters on two or more protective shells may or may not collide to temporarily link the two or more protective shells during retraction and/or the opposite.

According to an aspect of a preferred embodiment of the invention, any layered low-profile soft fluidic actuators may be integrated to at least one backing structure with uni-body protective element.

According to an aspect of a preferred embodiment of the invention, the uni-body protective element may be created to have physical properties including size, shape, thickness, materials, and curvatures.

According to an aspect of a preferred embodiment of the invention, the layered low-profile soft fluidic actuator can be attached to an interchangeable and/or swappable modular plate attachment mechanism.

According to an aspect of a preferred embodiment of the invention, the swappable modular plate may be attached to one or more surfaces and/or points of the layered low-profile soft fluidic actuators, as well as one or more surfaces and/or points of the backing layer.

According to an aspect of a preferred embodiment of the invention, the swappable modular plate may connect to the layered low-profile soft fluidic actuator via any connection mechanism.

According to an aspect of a preferred embodiment of the invention, the layered low-profile soft fluidic actuator can be attached to a slotted modular plate attachment mechanism with a minimum of two plates linked with a minimum of one other structure.

According to an aspect of a preferred embodiment of the invention, the slotted modular plate may not involve opening and/or closing of the backing structure but utilizes the separated slots which are inserted into the slots of the backing structure.

According to an aspect of a preferred embodiment of the invention, the slotted modular plate may incorporate at least a slot and/or gap and/or opening to allow at least one fluidic conduit to be connected with the layered low-profile soft fluidic actuator.

According to an aspect of a preferred embodiment of the invention, the slotted modular plate may have any physical properties including but not limited to size, shape, thickness, volume, and/or materials.

According to an aspect of a preferred embodiment of the invention, the layered low-profile soft fluidic actuator may be attached to one or more backing structure in which it incorporates a spring-damper mechanism and/or orientation sensors and/or motion sensors, and/or protective element.

According to an aspect of a preferred embodiment of the invention, the backing structure may have at least one cavity and/or opening within the structure for placement of at least one spring-damper mechanism and/or orientation sensors and/or motion sensors and/or fluidic conduits and/or any combination thereof.

According to an aspect of a preferred embodiment of the invention, the layered low-profile soft fluidic actuator may be attached with surface-hugging fluidic conduit protection element, which may be rigid, flexible, and/or elastic.

According to an aspect of a preferred embodiment of the invention, the surface-hugging fluidic conduit protection element may be covering a varied amount of the fluidic conduit connected to the layered low-profile soft fluidic actuator.

According to an aspect of a preferred embodiment of the invention, the fluidic distribution mechanism may incorporate parallel inflows into multiple layered low-profile soft fluidic actuators and parallel outflows out of the same layered low-profile soft fluidic actuators. These layered low-profile soft fluidic actuators may have varied and/or varying fluidic resistance and/or fluidic capacitance. The inflow and outflow pathways may also be switched bidirectionally to attain a sequenced inflation/pressurization or deflation/depressurization and/or vacuum for at least two layered low-profile soft fluidic actuators.

According to an aspect of a preferred embodiment of the invention, the fluidic distribution mechanism may incorporate the inflow to outflow in series through multiple layered low-profile soft fluidic actuators. While the inflow and outflow pathway may also be switched bidirectionally, only one flow direction is permitted at a time. These layered low-profile soft fluidic actuators may become the fluidic capacitor and/or fluidic resistor and/or fluidic conduit.

According to an aspect of a preferred embodiment of the invention, the fluidic distribution mechanism may be incorporated with any number of fluidic pressurization source, and/or fluidic filters, and/or fluidic pressurization reservoirs, and/or fluidic control valves, and/or fluidic depressurization sources, and/or fluidic depressurization reservouirs, and/or fluidic silencers/mufflers, and/or layered low-profile soft fluidic actuators with/without fluidic pressure/flow sensors.

According to an aspect of a preferred embodiment of the invention, any number of the layered low-profile soft fluidic actuator may be attached to at least two backing structures to formulate a multi-degree of freedom joint.

According to an aspect of a preferred embodiment of the invention, the multi-degree of freedom joint comprised of two or more layered low-profile soft fluidic actuator may linearly move back and forth along an axis, and/or tilt to achieve different orientations, and/or any combination thereof.

According to an aspect of a preferred embodiment of the invention, the multi-degree of freedom joint may be comprised of two or more layered low-profile soft fluidic actuators and two or more backing structures of any shape and size.

According to an aspect of a preferred embodiment of the invention, the profile of the multi-degree of freedom joint may be very thin when the layered low-profile soft fluidic actuators are fully and/or nearly fully depressurized and/or vacuumed.

According to an aspect of a preferred embodiment of the invention, the backing structures of the multi-degree of freedom joint may have any shapes, and/or sizes, and/or physical properties.

According to an aspect of a preferred embodiment of the invention, the layered low-profile soft fluidic actuators may be of any shapes and/or sizes and/or surface area in contact with the backing layer.

According to an aspect of a preferred embodiment of the invention, any number of multi-degree of freedom joints may be stacked to increase further range of motion and degree of freedom.

According to an aspect of a preferred embodiment of the invention, the multi-degree of freedom joint may incorporate a protective layer around the layered low-profile soft fluidic actuators.

According to an aspect of a preferred embodiment of the invention, the integration of single-joint manipulators attached permanently and/or partially to multi-degree of freedom joint is operable as an end effector for harvesting fruit and/or vegetables and/or handling objects. The single-joint manipulators may be comprised of at least one layered low-profile soft fluidic actuators which may be protected by a protective element, and/or attached to at least two backing structures which may be connected by a motion mechanism. The multi-degree of freedom joint provides prismatic and tilting motion of the end-effector to enable more dexterous movements.

According to an aspect of a preferred embodiment of the invention, the integration of five multi-joint manipulators which may be comprised of any number of backing structures, layered low-profile soft fluidic actuators, motion mechanisms, sensors, and/or modules, is operable as a robotic end-effector mimicking a human hand. Each interphalanx may contain at least one layered low-profile soft fluidic actuator, to attain bending and/or retraction motion to mimick flexion and extension, and/or to mimick adduction and abduction of fingers. It may also incorporate a palm cover to attain the curvature of the human hand.

According to an aspect of a preferred embodiment of the invention, the integration of five multi-joint manipulators which may be comprised of any number of backing structures, layered low-profile soft fluidic actuators, motion mechanisms, sensors, and/or modules, are operable as a robotic system mimicking a human foot. Each interphalanx may contain at least one layered low-profile soft fluidic actuator, to attain bending and/or retraction motion to mimick flexion and extension, and/or to mimick adduction and abduction of toes.

According to an aspect of a preferred embodiment of the invention, an LLPSFA may comprise any number and/or type of through-holes. The through-hole may allow any type and number of components to pass through it. The through-hole may also allow LLPSFA to remain straight and avoid any buckling during pressurization and/or depressurization. The LLPSFA with at least one through-hole may produce generally linear and/or rotational motion, force, and/or torque.

According to an aspect of a preferred embodiment of the invention, an LLPSFA for providing preferably bending and/or rotational motion, force, and/or pressure may have at least one tether and/or at least one pivot point. The fluid pressurization chamber of the LLPSFA may connect to at least one tether, which connects to at least one pivot point. One advantage of a tethered system may be that it prevents buckling of LLPSFA during bending and/or rotational motion. Another advantage of a tethered system may be that it prevents outward bulging of LLPSFA during rotational and/or bending motion.

According to any aspect of the embodiments of the present invention, an LLPSFA with or without any associated components and/or modules mentioned herein may also function as a sensor.

According to any aspect of the embodiments of the present invention, an LLPSFA with or without any associated components and/or modules mentioned herein may function tandemly and/or simultaneously as a sensor and actuator.

Other advantages, features and characteristics of the present invention, as well as methods of operation and functions of the related elements of the structure, and the combination of parts and economies of manufacture, will become more apparent upon consideration of this detailed description with reference to the figures which accompany this application.

### BRIEF DESCRIPTION OF THE SEVERAL VIEWS OF THE DRAWINGS

Embodiments of the subject-matter disclosed herein use a layered low-profile soft fluidic actuator which, when pressurized, achieves movement with a much higher range of motion and imparts and/or create forces and/or torques with much lower pressurization and/or vacuum than prior techniques. When depressurized and/or vacuumed, the layered low-profile soft fluidic actuators'overall form factor becomes extremely thin and flat, allowing them to fit into small gaps used for and/or as micro-actuators as well as macro-sized actuators. Additional advantages of the layered low-profile soft fluidic actuator and its associated systems and components, and modules will become abundantly clear from the detailed description included herein.

The novel features which are believed to be characteristic of the present invention, and related systems and methods according to the present invention, as to their structure, organization, use and method of operation, together with further objectives and advantages thereof, may be better understood from figures which accompany this application, in which presently preferred embodiments of the invention are illustrated by way of example. However, it is expressly understood that any such figures are for the purpose of illustration and description only and not intended as a definition of the limits of the invention. In the accompanying figures:

FIG. 1 is a diagram depicting a system including the major modules as well as sub-components of each major module;

FIG. 2A is a perspective view of layered low-profile soft fluidic actuators when nearly fully and/or fully deflated/depressurized and/or vacuumed for providing linear motion, force, and/or pressure;

FIG. 2B is a top perspective view of layered low-profile soft fluidic actuators when nearly fully and/or fully deflated/depressurized and/or vacuumed for providing linear motion, force, and/or pressure;

FIG. 2C is a section view of layered low-profile soft fluidic actuators when nearly fully and/or fully deflated/depressurized and/or vacuumed for providing linear motion, force, and/or pressure as seen in FIG. 2B;

FIG. 2D is a close-up detailed section view of the center of the layered low-profile soft fluidic actuators when nearly fully and/or fully deflated/depressurized and/or vacuumed for providing linear motion, force, and/or pressure as seen in FIG. 2C;

FIG. 2E is a close-up detailed section view of the outer edge of the layered low-profile soft fluidic actuators when nearly fully and/or fully deflated/depressurized and/or vacuumed for providing linear motion, force, and/or pressure as seen in FIG. 2C;

FIG. 3A is a perspective view of slightly inflated/pressurized layered low-profile soft fluidic actuators for providing linear motion, force, and/or pressure;

FIG. 3B is a top perspective view of slightly inflated/pressurized layered low-profile soft fluidic actuators for providing linear motion, force, and/or pressure;

FIG. 3C is a section view of slightly inflated/pressurized layered low-profile soft fluidic actuators for providing linear motion, force, and/or pressure as seen in FIG. 3B;

FIG. 4A is a perspective view of layered low-profile soft fluidic actuators when nearly fully and/or fully inflated/pressurized for providing linear motion, force, and/or pressure;

FIG. 4B is a top perspective view of layered low-profile soft fluidic actuators when nearly fully and/or fully inflated/pressurized for providing linear motion, force, and/or pressure;

FIG. 4C is a section view of layered low-profile soft fluidic actuators when nearly fully and/or fully inflated/pressurized for providing linear motion, force, and/or pressure as seen in FIG. 4B;

FIG. 5A is a perspective view of layered low-profile soft fluidic actuators when nearly fully and/or fully deflated/depressurized and/or vacuumed for providing bending and/or rotation motion, force, and pressure;

FIG. 5B is a top perspective view of layered low-profile soft fluidic actuators when nearly fully and/or fully deflated/depressurized and/or vacuumed for providing bending and/or rotation motion, force, and pressure;

FIG. 5C is a section view of layered low-profile soft fluidic actuators when nearly fully and/or fully deflated/depressurized and/or vacuumed for providing bending and/or rotation motion, force, and pressure as seen in FIG. 5B;

FIG. 5D is a close-up detailed section view of the expanding structure of layered low-profile soft fluidic actuators when nearly fully and/or fully deflated/depressurized and/or vacuumed for providing bending and/or rotation motion, force, and pressure as seen in FIG. 5C;

FIG. 5E is a close-up detailed section view of the outer edge of the linkage structure of layered low-profile soft fluidic actuators when nearly fully and/or fully deflated/depressurized and/or vacuumed for providing bending and/or rotation motion, force, and pressure as seen in FIG. 5C;

FIG. 6A is a section view of layered low-profile soft fluidic actuators when slightly inflated/pressurized for providing bending and/or rotation motion, force, and pressure;

FIG. 6B is a close-up detailed section view of layered low-profile soft fluidic actuators when slightly inflated/pressurized for providing bending and/or rotation motion, force, and pressure as seen in FIG. 6A;

FIG. 7A is a side perspective view of two-layer layered low-profile soft fluidic actuators with the linkage structure bonded at common center of rotation when inflated/pressurized for providing bending and/or rotation motion, force and pressure;

FIG. 7B is a side perspective view of three-layer layered low-profile soft fluidic actuators with the linkage structure bonded at common center of rotation when inflated/pressurized for providing bending and/or rotation motion, force and pressure;

FIG. 7C is a side perspective view of four-layer layered low-profile soft fluidic actuators with the linkage structure bonded at common center of rotation when inflated/pressurized for providing bending and/or rotation motion, force and pressure;

FIG. 8A is a side perspective view of four-layer layered low-profile soft fluidic actuators with only the expanding structure without the linkage structure and bonded at a common center of rotation, when inflated/pressurized for providing bending and/or rotation motion, force and pressure;

FIG. 8B is a section view of the four-layer layered low-profile soft fluidic actuators shown in FIG. 8A when inflated/pressurized for providing bending and/or rotation motion, force and pressure;

FIG. 9A is a circular shape of the selective embodiments of layered low-profile soft fluidic actuators as viewed from the top, which defines the shape of the layers of the layered low-profile soft fluidic actuators when deflated/depressurized and/or vacuumed;

FIG. 9B is a square/quadrilateral shape of the selective embodiments of layered low-profile soft fluidic actuators as viewed from the top, which defines the shape of the layers of the layered low-profile soft fluidic actuators when deflated/depressurized and/or vacuumed;

FIG. 9C is a pentagon shape of the selective embodiments of layered low-profile soft fluidic actuators as viewed from the top, which defines the shape of the layers of the layered low-profile soft fluidic actuators when deflated/depressurized and/or vacuumed;

FIG. 9D is an octagon shape of the selective embodiments of layered low-profile soft fluidic actuators as viewed from the top, which defines the shape of the layers of the layered low-profile soft fluidic actuators when deflated/depressurized and/or vacuumed;

FIG. 9E is an ellipse shape of the selective embodiments of layered low-profile soft fluidic actuators as viewed from the top, which defines the shape of the layers of the layered low-profile soft fluidic actuators when deflated/depressurized and/or vacuumed;

FIG. 9F is an irregular shape of the selective embodiments of layered low-profile soft fluidic actuators as viewed from the top, which defines the shape of the layers of the layered low-profile soft fluidic actuators when deflated/depressurized and/or vacuumed;

FIG. 10A is a side perspective view of the layered low-profile soft fluidic actuator with only the expanding structure without the linkage structure and bonded at a common location, integrated with the backing structures providing the common center of rotation for bending and/or rotation motion when inflated/pressurized;

FIG. 10B is a side perspective view of the layered low-profile soft fluidic actuator with the linkage structure, integrated with the backing structures providing the common center of rotation for bending and/or rotation motion when inflated/pressurized;

FIG. 10C is a side perspective view of the layered low-profile soft fluidic actuator with only the expanding structure without the linkage structure and without a common bonding location, integrated with the backing structures providing the common center of rotation for bending and/or rotation motion when inflated/pressurized;

FIG. 11A is a perspective view of the armadillo-inspired multi-component protective element included in addition to the backing structure with the layered low-profile soft fluidic actuator at deflated/depressurized and/or vacuumed state, providing protection of the layered low-profile soft fluidic actuator;

FIG. 11B is a front perspective view of the multi-component protective element included in addition to the backing structure with the layered low-profile soft fluidic actuator at deflated/depressurized and/or vacuumed state;

FIG. 11C is a sectional view of the multi-component protective element included in addition to the backing structure with the layered low-profile soft fluidic actuator at deflated/depressurized and/or vacuumed state, revealing the full-span and full-retraction motion limiters;

FIG. 11D is a side perspective view of the multi-component protective element included in addition to the backing structure with the layered low-profile soft fluidic actuator at deflated/depressurized and/or vacuumed state;

FIG. 11E is a perspective view of the armadillo-inspired multi-component protective element included in addition to the backing structure with the layered low-profile soft fluidic actuator at inflated/pressurized state, providing protection of the layered low-profile soft fluidic actuator;

FIG. 11F is a front perspective view of the armadillo-inspired multi-component protective element included in addition to the backing structure with the layered low-profile soft fluidic actuator at inflated/pressurized state;

FIG. 11G is a sectional view of the multi-component protective included in addition to the backing structure with the layered low-profile soft fluidic actuator at inflated/pressurized state, revealing the full-span and full-retraction motion limiters;

FIG. 11H is a side perspective view of the multi-component protective element included in addition to the backing structure with the layered low-profile soft fluidic actuator at inflated/pressurized state;

FIG. 12A is a perspective view of the uni-body protective element integrated as part of the backing structure with the low-profile soft fluidic actuator at deflated/depressurized and/or vacuumed state, providing protection of the layered low-profile soft fluidic actuator;

FIG. 12B is a front perspective view of the uni-body protective integrated as part of the backing structure with the layered low-profile soft fluidic actuator at deflated/depressurized and/or vacuumed state;

FIG. 12C is a sectional view of the uni-body protective element integrated as part of the backing structure with the layered low-profile soft fluidic actuator at deflated/depressurized and/or vacuumed state, revealing cavity allowing the integration of the uni-body protective element;

FIG. 12D is a side perspective view the uni-body protective element integrated as part of the backing structure with the layered low-profile soft fluidic actuator at deflated/depressurized and/or vacuumed state;

FIG. 12E is a perspective view of the uni-body protective element integrated as part of the backing structure with the layered low-profile soft fluidic actuator at inflated/pressurized state, providing protection of the layered low-profile soft fluidic actuator;

FIG. 12F is a front perspective view of the uni-body protective element integrated as part of the backing structure with the layered low-profile soft fluidic actuator at inflated/pressurized state;

FIG. 12G is a sectional view of the uni-body protective element integrated as part of the layered low-profile soft fluidic actuator at inflated/pressurized state, revealing cavity allowing the integration of the uni-body protective element;

FIG. 12H is a side perspective view of the uni-body protective element integrated as part of the backing structure with the layered low-profile soft fluidic actuator at inflated/pressurized state;

FIG. 13A is a side perspective view of the layered low-profile soft fluidic actuator with the modular plate as an attachment module and the backing structures, with the backing structures opened up for the attachment module insertion;

FIG. 13B is a side perspective view of the layered low-profile soft fluidic actuator with the modular plate as an attachment module and the backing structures, during the insertion process of the attachment module;

FIG. 13C is a side perspective view of the layered low-profile soft fluidic actuator with the modular plate as an attachment module and the backing structures, with the attachment module inserted and secured onto the backing structures;

FIG. 14A is a side perspective view of the layered low-profile soft fluidic actuator with the slotted modular plate as an attachment module and the slotted backing structures prior to the insertion process of the attachment module;

FIG. 14B is a side perspective view of the layered low-profile soft fluidic actuator with the slotted modular plate as an attachment module and the slotted backing structures with the attachment module inserted and secured onto the backing structures via the slots;

FIG. 15A is a side perspective view of the backing structures integrated with flexible and/or elastic protective element for layered low-profile soft fluidic actuator and cavity for placement of spring-damper mechanism and/or orientation sensors and/or motion sensors;

FIG. 15B is a side perspective view of the surface-hugging fluidic conduit protection element equipped onto the fluid conduits connected to the layered low-profile soft fluidic actuator;

FIG. 16A is a schematic drawing of the fluidic distribution mechanism for the layered low-profile soft fluidic actuator in the parallel configuration;

FIG. 16B is a schematic drawing of the fluidic distribution mechanism for the layered low-profile soft fluidic actuator in the series configuration;

FIG. 17 is a schematic drawing showing the potential fluid pathways, fluid flow directions, fluidic conduits, and any other components associated with the fluidic interaction of and/or fluidly connected to the layered low-profile soft fluidic actuator;

FIG. 18A is a side perspective view of the multi-degree of freedom joint enabled by three layered low-profile soft fluidic actuators integrated into two backing structures when all the layered low-profile soft fluidic actuators are at deflated/depressurized and/or vacuumed state;

FIG. 18B is a top perspective view of the multi-degree of freedom joint enabled by three layered low-profile soft fluidic actuators integrated into two backing structures when all the layered low-profile soft fluidic actuators are at deflated/depressurized and/or vacuumed state;

FIG. 18C is a perspective view of the multi-degree of freedom joint enabled by three layered low-profile soft fluidic actuators integrated into two backing structures when all the layered low-profile soft fluidic actuators are at deflated/depressurized and/or vacuumed state;

FIG. 18D is a side perspective view of the multi-degree of freedom joint enabled by three layered low-profile soft fluidic actuators integrated into two backing structures when all the layered low-profile soft fluidic actuators are at inflated/pressurized state to provide prismatic motion;

FIG. 18E is a top perspective view of the multi-degree of freedom joint enabled by three layered low-profile soft fluidic actuators integrated into two backing structures when all the layered low-profile soft fluidic actuators are at inflated/pressurized state to provide prismatic motion;

FIG. 18F is a perspective view of the multi-degree of freedom joint enabled by three layered low-profile soft fluidic actuators integrated into two backing structures when all the layered low-profile soft fluidic actuators are at inflated/pressurized state to provide prismatic motion;

FIG. 18G is a side perspective view of the multi-degree of freedom joint enabled by three layered low-profile soft fluidic actuators integrated into two backing structures when one of the actuators is deflated/vacuumed while the other two are inflated/pressurized, to provide tilting motion;

FIG. 18H is a top perspective view of the multi-degree of freedom joint enabled by three layered low-profile soft fluidic actuators integrated into two backing structures when one of the actuators is deflated/vacuumed while the other two are inflated/pressurized, to provide tilting motion;

FIG. 18I is a perspective view of the multi-degree of freedom joint enabled by three layered low-profile soft fluidic actuators integrated into two backing structures when one of the actuators is deflated/vacuumed while the other two are inflated/pressurized, to provide tilting motion;

FIG. 18J is a side perspective view of the multi-degree of freedom joint enabled by two layered low-profile soft fluidic actuators integrated into two backing structures, which allows linear and/or tilting motion;

FIG. 18K is a perspective view of the multi-degree of freedom joint enabled by four layered low-profile soft fluidic actuators integrated into two backing structures;

FIG. 18L is a perspective view of the multi-degree of freedom joint enabled by four layered low-profile soft fluidic actuators integrated into two square-shaped backing structures;

FIG. 18M is a perspective view of the multi-degree of freedom joint enabled by four layered low-profile soft fluidic actuators integrated into two irregularly-shaped backing structures;

FIG. 19A is a perspective view of the multi-degree of freedom joint with larger surface area of contact between the three layered low-profile soft fluidic actuators and the backing structure when all the layered low-profile soft fluidic actuators are at inflated/pressurized state;

FIG. 19B is a perspective view of the multi-degree of freedom joint with larger surface area of contact when all the layered low-profile soft fluidic actuators are at inflated/pressurized state, without the top part of the backing structure for illustration purposes;

FIG. 19C is a perspective view of the multi-degree of freedom joint with larger surface area of contact when all the layered low-profile soft fluidic actuators are at inflated/pressurized state, with the prospective element enclosing the sides;

FIG. 19D is a side perspective view of the multi-degree of freedom joint with larger surface area of contact between the three-layered low-profile soft fluidic actuators and the backing structure when all the layered low-profile soft fluidic actuators are at deflated/depressurized and/or vacuumed state;

FIG. 19E is a side perspective view of the multi-degree of freedom joint with larger surface area of contact between the three-layered low-profile soft fluidic actuators and the backing structure when all the layered low-profile soft fluidic actuators are at inflated/pressurized state;

FIG. 19F is a top perspective view of the multi-degree of freedom joint with larger surface area of contact between the three-layered low-profile soft fluidic actuators and the backing structure;

FIG. 19G is a perspective view of the multi-degree of freedom joint with larger surface area of contact between the three layered low-profile soft fluidic actuators and the backing structure when some of the layered low-profile soft fluidic actuators are at partially inflated/pressurized state and some others are at partially deflated/depressurized and/or vacuumed state;

FIG. 19H is a perspective view of the multi-degree of freedom joint with larger surface area of contact between the three layered low-profile soft fluidic actuators and the backing structure when all the layered low-profile soft fluidic actuators are at different stages of the inflated/pressurized state;

FIG. 20 is a perspective view of an embodiment in the form of a robotic end effector designed for handling delicate objects comprised of vision sensors, motion sensors, three single joint manipulators each enabled by layered low-profile soft fluidic actuators, and multi-degree of freedom joint shown at fully inflated/pressurized state;

FIG. 21A is a perspective view of an embodiment in the form of a robotic end-effector mimicking a human hand designed for demonstrating key dexterous features of human finger motions, comprised of layered low-profile soft fluidic actuators at each interphalangeal and/or metacarpophalangeal and/or carpometacarpo joint and additional actuators allowing abduction/adduction motion of the digits and/or circumduction motion of the thumb, prior to insertion of a palm casing;

FIG. 21B is a perspective view of an embodiment in the form of a robotic end-effector mimicking a human hand designed for demonstrating key dexterous features of a human finger motion, comprised of layered low-profile soft fluidic actuators at each interphalangeal and/or metacarpophalangeal and/or carpometacarpo joint and additional actuators allowing abduction/adduction motion of the digits and/or circumduction motion of the thumb, with the insertion of a palm casing;

FIG. 21C is a front perspective view of an embodiment in the form of a robotic end-effector mimicking a human hand designed for demonstrating key dexterous features of human finger motions, comprised of layered low-profile soft fluidic actuators at each interphalangeal and/or metacarpophalangeal and/or carpometacarpo joint and additional actuators allowing abduction/adduction motion of the digits and/or circumduction motion of the thumb, with the insertion of a palm casing;

FIG. 21D is a side perspective view of an embodiment in the form of a robotic end-effector mimicking a human hand designed for demonstrating key dexterous features of human finger motions, comprised of layered low-profile soft fluidic actuators at each interphalangeal and/or metacarpophalangeal and/or carpometacarpo joints and additional actuators allowing abduction/adduction motion of the digits and/or circumduction motion of the thumb, with the insertion of a palm casing;

FIG. 21E is a front sectional view of an embodiment in the form of a robotic end-effector mimicking a human hand designed for demonstrating key dexterous features of human finger motions, comprised of layered low-profile soft fluidic actuators at each interphalangeal and/or metacarpophalangeal and/or carpometacarpo joint and additional actuators allowing abduction/adduction motion of the digits and/or circumduction motion of the thumb, with the insertion of a palm casing;

FIG. 21F is a perspective view of the robotic hand demonstrating the abduction motion occurs when the layered low-profile soft fluidic actuators between the fingers are at inflated/pressurized state, as well as the thumb motion which occurs when the interphalangeal and/or metacarpophalangeal and/or carpometacarpo layered low-profile soft fluidic actuators of the thumb are at inflated/pressurized state;

FIG. 21G is a back perspective view of the robotic hand demonstrating the abduction motion occurs when the layered low-profile soft fluidic actuators between the fingers are at inflated/pressurized state, as well as the thumb grasping motion which occurs when the interphalangeal and/or metacarpophalangeal and/or carpometacarpo layered low-profile soft fluidic actuators of the thumb are at inflated/pressurized state;

FIG. 21H is a perspective view of the robotic hand demonstrating the grasping motion of the four fingers which occurs when the interphalangeal and/or metacarpophalangeal layered low-profile soft fluidic actuators of the fingers are at inflated/pressurized state, while the thumb has been fully retracted which occurs when the interphalangeal and/or metacarpophalangeal and/or carpometacarpo layered low-profile soft fluidic actuators of the thumb are at fully deflated/depressurized and/or vacuumed state;

FIG. 22A is a perspective view of an embodiment in the form of a robotic system mimicking a human foot, comprised of layered low-profile soft fluidic actuators at each joint;

FIG. 22B is a different perspective view of an embodiment in the form of a robotic system mimicking a human foot, comprised of layered low-profile soft fluidic actuators at each joint, with the actuators removed to demonstrate the motion mechanism at each joint;

FIG. 22C is a top sectional view of an embodiment in the form of a robotic system mimicking a human foot, comprised of layered low-profile soft fluidic actuators at each joint, additionally demonstrating the abduction/adduction capability of the digits;

FIG. 23A is a perspective view of a layered low-profile soft fluidic actuator at inflated/pressurized state, with one common through-hole located at the center;

FIG. 23B is a side perspective view of a layered low-profile soft fluidic actuator at inflated/pressurized state, with one common through-hole located at the center;

FIG. 23C is a side sectional view of a layered low-profile soft fluidic actuator at inflated/pressurized state, with one common through-hole located at the center which is not connected to the internal structure of the layered low-profile soft fluidic actuator, and all layers of the actuators internally connected;

FIG. 23D is a side sectional view of a layered low-profile soft fluidic actuator at inflated/pressurized state, with one common through-hole located at the center which is not connected to the internal structure of the layered low-profile soft fluidic actuator, and the layers of one side of the actuator are internally connected while the layers on other side of the actuator are not internally connected;

FIG. 23E is a perspective view of a layered low-profile soft fluidic actuator at deflated/depressurized and/or vacuumed state, with one common through-hole located at the center;

FIG. 23F is a side perspective view of a layered low-profile soft fluidic actuator at deflated/depressurized and/or vacuumed state, with one common through-hole located at the center;

FIG. 23G is a perspective view of a layered low-profile soft fluidic actuator at deflated/depressurized and/or vacuumed state, with more than one common through-hole located at the center in which the shapes can be circular, square, and/or any irregular shape;

FIG. 24A is a side perspective view of a four-layer layered low-profile soft fluidic actuator at inflated/pressurized state, with each having an addition of a tether to the common pivot point;

FIG. 24B is a top perspective view of a layered low-profile soft fluidic actuator with tethers of the actuators connected to common pivoting axis orthogonally;

FIG. 24C is a top perspective view of offsetted layered low-profile soft fluidic actuators with different sizes of the tethers of the actuators connected to common pivoting axis with different angles;

FIG. 24D is a top perspective view of layered low-profile soft fluidic actuators, each of the three actuators are offsetted from one another with a tether connected to a common pivoting point.

It is to be understood that the accompanying drawings are used for illustrating the principles of the embodiments and exemplifications of the invention discussed below. Hence the drawings are illustrated for simplicity and clarity, and not necessarily drawn to scale and are not intended to be limiting in scope. Reference characters/numbers are used to depict the elements of the invention discussed that are also shown in the drawings. The same corresponding reference characters/numbers are given to a corresponding component or components of the same or similar nature, which may be depicted in multiple drawings for clarity. In particular, specific embodiments or categories of embodiments of an element designated by a particular reference character may be distinguished by means of a suffix, wherein the specific embodiment designated by a reference character having a suffix is a species of the more general element having the same reference character lacking the suffix. For example, an element shown in the drawings and designated by the reference character ###n is a species of the more general element designated by reference character ###, and thus possesses all of the features of the more general element. Text may also be included in the drawings to further clarify certain principles or elements of the invention. It should be noted that features depicted by one drawing may be used in conjunction with or within other drawings or substitute features of other drawings. It should further be noted that common and well-understood elements for creating a commercially viable version of the embodiments of the invention discussed below are often not depicted to facilitate a better view of the principles and elements of the invention discussed below.

### DETAILED DESCRIPTION OF THE INVENTION

In the following discussion, the accompanying figures pertain to the preferred embodiments, and the description is not intended to limit the scope, applicability or configuration of the invention as described by the claims. The description enclosed herein aims to provide any person skilled in the art with the necessary information for the implementation of the preferred embodiments of the invention described herein.

Below is some clarification for certain terminologies; it must be noted that the clarifications do not limit the scope of the meaning of the terminologies in the context of the relevant art, and the invention described herein.

“Soft robots,” “systems,” and “device” may be used interchangeably unless explicitly stated otherwise.

“Inflated” and “pressurized” may be used interchangeably unless explicitly stated otherwise.

“Deflated” and “depressurized” may be used interchangeably unless explicitly stated.

“Vacuum” may mean any amount of negative pressure compared to the external environment created within an layered low-profile soft fluidic actuators and/or any fluidic components.

“Fluid” may be of any type and/or any mixture of gas, liquid, specialty fluid, magnetic fluid, electrical-driven fluid, Newtonian, non-Newtonian fluid, and indeed any type and/or kind of fluid under any condition, which may include but is not limited to temperature, pressure, compressible and/or incompressible flow, laminar and/or turbulent flow, subsonic and/or supersonic speed.

Singular forms, including but not limited to “a” and “an,” may also comprise the meaning of plural forms as well, unless explicitly stated otherwise.

Additionally, plural forms may also comprise the meaning of singular forms unless explicitly stated otherwise.

Throughout this description, the term “invention” means the entirety of the subject-matter disclosed in the specification and drawings, including any and all different embodiments thereof and any functional equivalents thereof, without limitation to any one or more such embodiments.

Throughout this description, unless expressly indicated otherwise, the expressions “may”, “may have”, “preferable”, and “preferably”, and similar expressions, designate some or different embodiments of the subject-matter disclosed herein which possess or are characterized by the conditions addressed by the expressions, without limitation to the entirety of the subject-matter disclosed herein. For example, the statement “a preferred embodiment of the invention may be X” means that in some embodiments of the disclosed subject-matter, the embodiment possesses or is characterized by ‘X’, without necessarily requiring any other embodiments of the disclosed subject-matter to possess or be characterized by X.

Numeric ranges recited herein are inclusive of the numbers defining the range and include each integer within the defined range. Throughout this disclosure, various aspects of the invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

The term “about,” as used herein, refers to variation in the numerical quantity that can occur, for example, through typical measuring techniques and equipment, with respect to any quantifiable variable, including, but not limited to, mass, volume, time, distance, voltage, and current. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations.

The phrase “and/or,” as used herein should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”. “Consisting essentially of”, when used in the claims, shall have its ordinary meaning as used in the field of patent law.

### i. System Overview

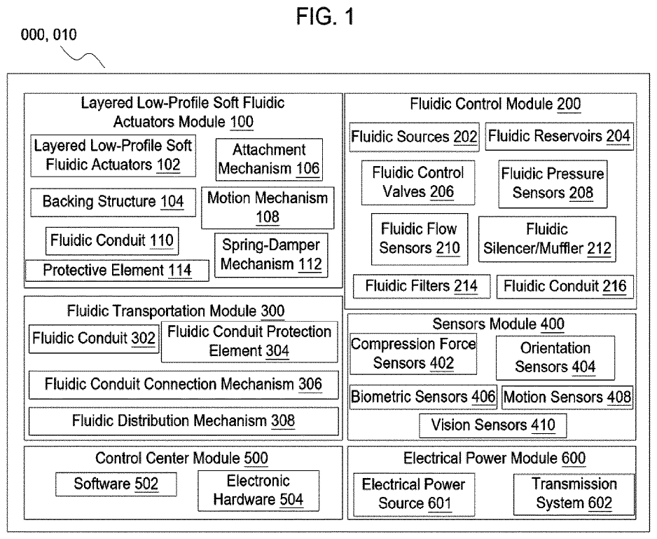

A layered low-profile soft fluidic actuator device, which will be coined as the overall system, comprises numerous major modules, and each major module has numerous sub-components. FIG. 1 is a schematic showing the major modules and their sub-components that make up the overall system 000 and/or sub-system 010 (i.e. not including all components and/or modules of the system). System 000 may be used interchangeably with sub-system 010. The major modules are as follows: the layered low-profile soft fluidic actuators module 100, the fluidic control module 200, the fluidic transportation module 300, the sensors module 400, the control center module 500, and the electrical power module 600. Each major module comprises various sub-components.

The layered low-profile soft fluidic actuators module 100 comprises the main soft robotic and/or soft-rigid hybrid robotic structure of the overall system 000, including but not limited to layered low-profile soft fluidic actuators 102, backing structure 104, attachment mechanism 106, motion mechanism 108, fluidic conduit 110, spring-damper mechanism 112, and/or protective element 114. The at least one layered low-profile soft fluidic actuator 102 may produce motion, force, and/or torque to itself and/or the at least one backing structure 104. At least one attachment mechanism 106 may allow each of the sub-components of the layered low-profile soft fluidic actuators module 100 to connect to at least one other sub-component permanently, semi-permanently, and/or detachably. At least one motion mechanism 108 may allow for the layered low-profile soft fluidic actuators module to produce motion, force, and/or torque to itself, a portion of itself, and/or at least one external object. At least one motion mechanism may also pose degree of freedom and/or motion restrictions on certain locations and/or aspects of the layered low-profile soft fluidic actuators module 100. At least one fluidic conduit 110 may connect at least one layered low-profile soft fluidic actuator 102 to any number of other layered low-profile soft fluidic actuators 102 and/or at least one fluidic components. The at least one spring-damper mechanism 112 may allow the at least one layered low-profile soft fluidic actuators module 100 to produce spring-damper modified motion, force, and/or torque. At least one spring-damper mechanism 112 may allow the layered low-profile soft fluidic actuators module 100 to return to its initial and/or certain physical state and/or condition. The protective element 114 protects the layered low-profile soft fluidic actuators module 100 and at least one of its subcomponents from at least one damaging and/or disrupting element, including but not limited to forces, torques, pressures, motions, and/or conditions.

The fluidic control module 200 comprises the system for providing, receiving, conditioning and sensing the fluid of the overall system 000, including but not limited to fluidic sources 202, fluidic reservoirs 204, fluidic control valves 206, fluidic pressure sensors 208, fluidic flow sensors 210, fluidic silencers/mufflers 212, fluidic filters 214, and fluidic conduits 216. At least one fluidic source 202 may provide fluidic flow and/or pressure for the overall system 000. At least one fluidic source 202 may also be a fluidic sink receiving fluidic flow and/or pressure for the overall system 000. At least one fluidic reservoir 204 may contain fluidic pressure and volume for the overall system 000. At least one fluidic control valve 206 may partially and/or fully open and/or partially and/or fully close at least one fluidic pathway of the overall system 000. At least one fluidic pressure sensor 208 may sense the fluidic pressure for at least a portion of the overall system 000, including but not limited to fluidic components within the layered low-profile soft fluidic actuators module 100, the fluidic control module, 200, and/or the fluidic transportation module 300 and/or subcomponents within these modules 100, 200, 300. At least one fluidic flow sensor may sense the fluidic flow for at least a portion of the overall system 000, including but not limited to fluidic components within the layered low-profile soft fluidic actuators module 100, the fluidic control module, 200, and/or the fluidic transportation module 300 and/or subcomponents within these modules 100, 200, 300. At least one fluidic silencer/muffler 212 may reduce the noise and/or vibration for at least a portion of the overall system 000, including but not limited to fluidic components within the layered low-profile soft fluidic actuators module 100, the fluidic control module, 200, and/or the fluidic transportation module 300 and/or subcomponents within these modules 100, 200, 300. At least one fluidic filter 214 may filter the fluidic flow for at least a portion of the overall system 000, including but not limited to fluidic components within the layered low-profile soft fluidic actuators module 100, the fluidic control module, 200, and/or the fluidic transportation module 300 and/or subcomponents within these modules 100, 200, 300. At least one fluidic conduit 216 may connect at least one subcomponent of the fluidic control module 200 to at least one other subcomponent of the fluidic control module 200 and/or at least one fluidic component of another module 100, 300.

The fluidic transportation module 300 transports fluidic flow and pressure between at least two fluidic components, including but not limited to the fluidic control module 200 and the layered low-profile soft fluidic actuators module 100 and/or subcomponents within these modules 100, 200. At least one fluidic conduit 302 may function as the main fluidic transportation pathway. Fluidic conduit 302 may also be mentioned as a fluid pathway. At least one fluidic conduit protection element 304 may protect the fluidic transportation module 300 and/or its subcomponents from at least one damaging and/or disrupting element, including but not limited to forces, torques, pressures, motions, and/or conditions. At least one fluidic conduit connection mechanism 306 may function as a permanent, semi-permanent, and/or detachable mechanism for connecting at least one subcomponent of the fluidic transportation module 300 with at least one other subcomponent of the fluidic transportation module 300 and/or at least one other subcomponents of the layered low-profile soft fluidic actuators module 100 and/or fluidic control module 200. The fluidic distribution mechanism 308 may distribute fluid from at least one location to at least one other location of the overall system 000.

The sensors module 400 may enable various control schemes of the layered low-profile soft fluidic actuators module 100 and various user experience features. The sensors module 400 comprises compression force sensors 402, orientation sensors 404, biometric sensors 406, motion sensors 408, vision sensors 410 and/or any other type of sensors necessary to produce commercially viable versions of the overall system 000.

The control center module 500 may be tasked with controlling the fluid flow rate, fluid flow direction, and/or fluid pressure of the fluidic control module 200, fluidic transportation module 300, and the layered low-profile soft fluidic actuators module 100. The control center module 500 is also tasked with receiving, analyzing, and interpreting information from various sensors. The control center module comprises software 502 and electronics hardware 504 responsible for every aspect of the overall system 000, which includes but is not limited to the function of each module and their subcomponents, the function of the sensors, user experience, user interface, electronic communications, and electrical powers distribution. The control center module 500 may also comprise any common and well-understood elements that would be necessary to produce a commercially viable control center module 500 for the overall system 000; these elements include but are not limited to a motherboard, central processing unit (CPU), data storage in the form of solid-state drives (SSD), wireless network systems, random access memory (RAM), various electrical subcomponents such as wires, traces, electrical resistors, capacitors, diodes, fuses, and various electronic subcomponents such as field-effective transistors and any other types of silicon transistors.

The electrical power module 600 provides electrical power to all the major modules and their subcomponents of the overall system 000. The electrical power module 600 may comprise at least one battery 601 and/or at least one electrical power transmission system 602. The electrical power module 600 may also comprise any common and well-understood elements necessary to produce a commercially viable electrical power module. In some instances, at least one battery 601 may be neglected and not included in the electrical power module 600. In some instances, the electrical power module 600 may not provide electrical power to certain major modules and/or their sub-components. At least one battery may be rechargeable and/or replaceable.

Any and all of the major modules and/or their subcomponents presented herein may be combined together as one element and/or container or separated into multiple elements and/or containers. Any container enclosing any module and/or their subcomponents may preferably, but need not necessarily, be elastic, flexible, rigid, or any combination thereof. Any and all of the major modules and/or their subcomponents presented herein may be integrated with the soft robot in selectively removable relation.

Various embodiments and exemplifications of the present invention are not limited by the major modules and their subcomponents mentioned; additional major modules and any sub-components to any above-mentioned major modules may be added to the overall system 000 to produce commercially-viable versions of the invention described herein. Also, one or more of the above-mentioned major modules and any subcomponents to any above-mentioned major modules may be removed from the overall system 000 to produce commercially viable versions of the invention described herein.

The layered low-profile soft fluidic actuators module 100 is the central module which all other modules and subcomponents revolve around. Layered low-profile soft fluidic actuator will be abbreviated LLPSFA. LLPSFA module 100 and associated components will be described first in detail below:

### ii. Layered Low-profile Soft Fluidic Actuators Module and Associated Components

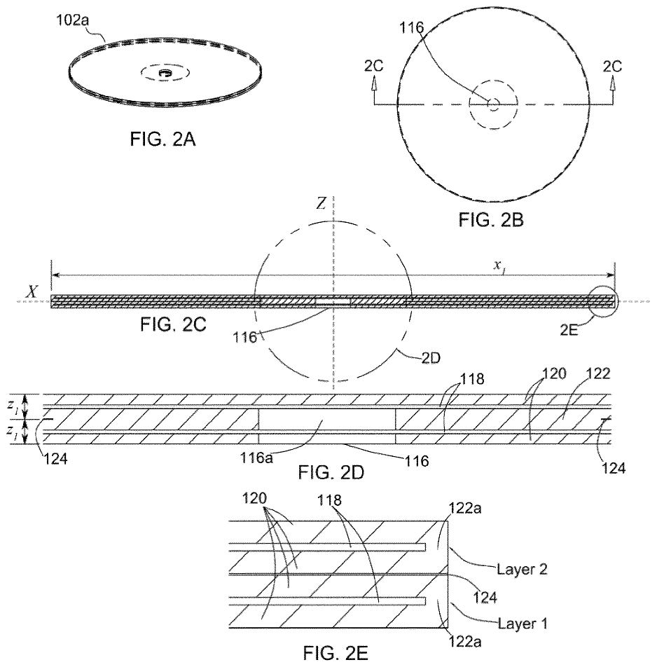

An embodiment of a fully, nearly fully, deflated/depressurized and/or vacuumed 2-layer LLPSFA 102a for providing preferably linear motion, force, and/or pressure is demonstrated in FIG. 2A to FIG. 2E. Fluid may enter and/or exist the 2-layer LLPSFA 102a via first layer (Layer 1) fluidic inlet 116. The fluid may then enter at least one subsequent layer (Layer 2) via the subsequent layer fluidic inlet 116a, which fluidly connects at least two layers. Internal LLPSFA's fluidic pressurization chamber 118, when deflated, has near zero volume, as demonstrated in the two close-up detailed section views (FIG. 2D, FIG. 2E). The walls 120 of the LLPSFA may form to create the fluidic pressurization chamber 118, holding the fluidic pressure within the fluidic pressurization chamber 118. The walls 120 may be elastic and/or flexible and/or any combination thereof. The walls 120 may be constructed out of a single material and/or numerous different materials and/or composite materials. The only pathway for fluid to enter and exit the LLPSFA is via the first layer fluidic inlet 116. Each layer of the LLPSFA may be bonded at certain locations 122 for each layer to be integrated as a single LLPSFA 102a. The walls of each layer may also be bonded at certain locations 122a to produce a seam to form a fluidly sealed fluidic pressurization chamber 118. The locations where no bonding occurs become outer 124 gaps that separate each layer of the LLPSFA. In certain embodiments of the invention described herein, any number of fluidic inlets may exist on any layer of LLPSFA. In certain embodiments of the present invention, any layer may not necessarily have direct fluid communication with each other's fluidic pressurization chamber and/or any fluidic components relating to each layer and/or any combination thereof.

As shown in FIG. 2C, the LLPSFA 102 may be characterized by an expansion axis Z and a transverse axis X orthogonal to the expansion axis, wherein the expansion axis is orthogonal to a plane of the walls of the fluidic actuator layers when the fluidic actuator is in a fully deflated state.

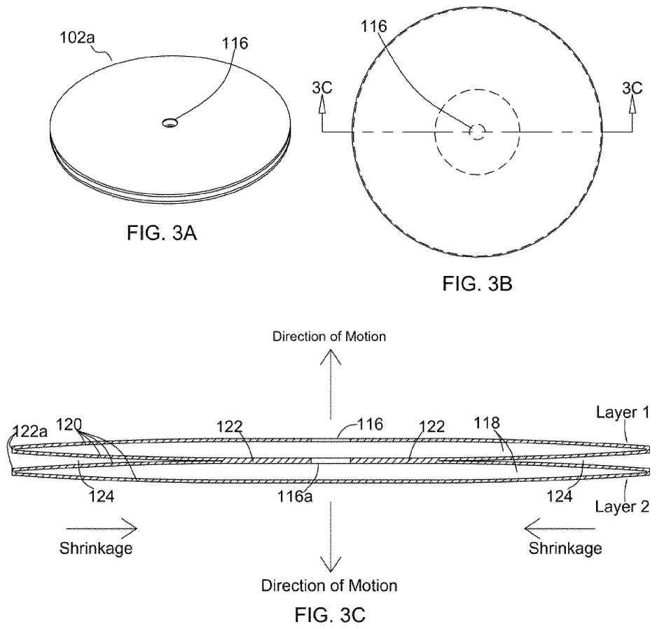

An embodiment of a slightly inflated/pressurized 2-layer LLPSFA 102a for providing preferably linear motion, force, and/or pressure is demonstrated in FIG. 3A to FIG. 3C. When slightly inflated, the 2-layer LLPSFA 102a may expand along the expansion axis Z, in the direction of motion shown by the two large vertical arrows while shrinking slightly along the transverse axis X, in the perpendicular direction of motion shown by the large horizontal arrows. When being deflated, the 2-layer LLPSFA 102a may shrink and/or compress along the expansion axis Z in the direction of motion opposite of the two large vertical arrows while expanding slightly along the transverse axis X, in the perpendicular direction of motion shown by the large horizontal arrows. At least one fluidic pressurization chamber 118 expands due to fluidic pressure increase, which enters from the fluidic inlet 116, 116a. At least one wall 120 curves outward under the expansion of the fluidic pressurization chamber 118. At least one wall 120 may elastically stretch. One or more bonded walls 122, 122a, may also expand, curve, and/or stretch. The gaps between each layer 124 become larger. Due to the curvature of at least one wall 120, the gap 124 is largest at the bonded seam 122a and smallest at the edge of the bonded walls 122 for layer integration.

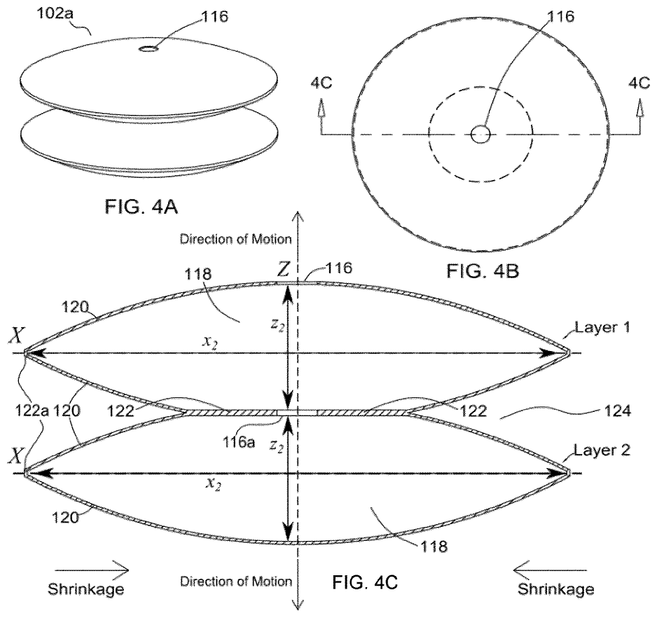

An embodiment of fully and/or almost fully inflated/pressurized 2-layer LLPSFA 102a for providing preferably linear motion, force, and/or pressure is demonstrated in FIG. 4A to FIG. 4C. When fully inflated and/or almost fully inflated, the 2-layer LLPSFA 102a may further expand along the expansion axis Z, in the direction of motion shown by the two large vertical arrows while shrinking slightly along the transverse axis X, in the perpendicular direction of motion shown by the large horizontal arrows. When being deflated, the 2-layer LLPSFA 102a may shrink and/or compress along the expansion axis Z in the direction of motion opposite of the two large vertical arrows while expanding slightly along the transverse axis X, in the opposite perpendicular direction of motion shown by the large horizontal arrows. One or more fluidic pressurization chamber 118 may further expand due to fluidic pressure increase, which enters from the fluidic inlet 116, 116a. One or more walls 120 may curve outward under the further expansion of the fluidic pressurization chamber 118. One or more walls 120 may elastically stretch. One or more bonded walls 122, 122a, may also further expand, curve, and/or stretch. The gaps between each layer 124 may further become larger. Due to the curvature of at least one wall 120, the gap 124 is largest at the bonded seam 122a and smallest at the edge of the bonded walls 122 for layer integration. The expansion of one or more fluidic pressurization chambers 118 and corresponding walls and bonded walls 120, 122, 122a may expand and/or stretch until the LLPSFA 102a materialistic and/or mechanically fail, which may include but not limited to bursting, leaking, breaking, puncturing, delaminating, plastically deforming, and/or fracturing.

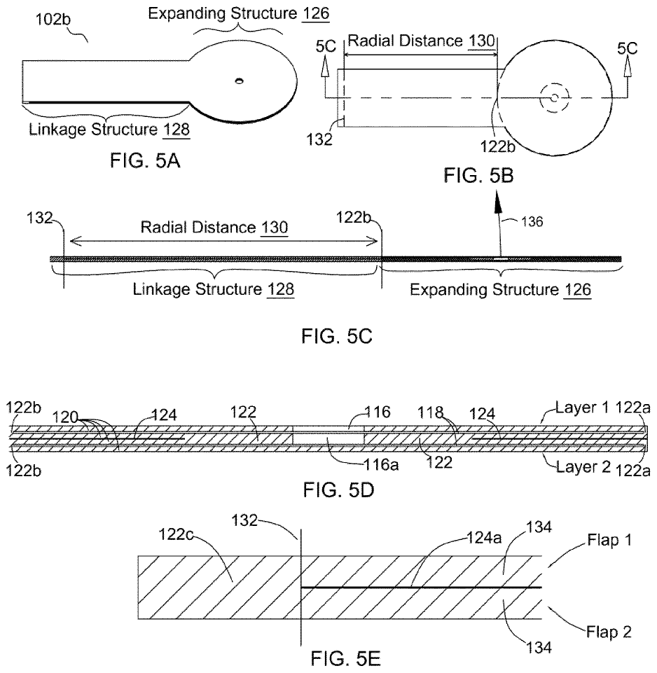

An embodiment of fully, nearly fully, deflated/depressurized, and/or vacuumed 2-layer LLPSFA 102b for providing preferably bending and/or rotation motion, force, and pressure is demonstrated in FIG. 5A to FIG. 5E. As seen in FIG. 5A to FIG. 5C, the LLPSFA 102b may comprise at least one expanding structure 126 and at least one linkage structure 128. The expanding structure 126 may comprise a first layer (Layer 1) fluidic inlet 116 and at least one subsequent layer (Layer 2) fluidic inlet 116a, wherein fluid may flow into and/or out of the expanding structure's internal fluidic pressurization chamber 118. When deflated, the expanding structure's internal fluidic pressurization chamber 118 has near-zero volume, as demonstrated in FIG. 5D. The walls 120 of the expanding structure form to create the fluidic pressurization chamber 118; holding the fluidic pressure within the fluidic pressurization chamber 118. The walls 120 may be elastic and/or flexible and/or any combination thereof. The walls 120 may be constructed out of a single material and/or numerous different materials and/or composite materials. The only pathway for fluid to enter and exit the fluidic pressurization chamber 118 is via the first layer fluidic inlet 116. In certain embodiments of the invention described herein, any number of fluidic inlets may exist on any layer of LLPSFA. Each layer of the expanding structure is bonded at certain locations 122 for each layer to be integrated as a single expanding structure 126. The walls of each layer are also bonded at certain locations 122a, 122b to produce a seam to form a fluidly sealed fluidic pressurization chamber 118. The locations where no bonding occurs become outer 124 gaps that separate each layer of the expanding structure 126. The expanding structure 126 shares one or more similar features to the LLPSFA seen in FIG. 2, FIG. 3, and FIG. 4. In particular, the expanding structure 126 may be, or may be substantially similar to, or may be a species of an LLPSFA 102 described herein. The linkage structure 128 may be unique to LLPSFA 102b for providing preferably bending motion, force, and pressure. The linkage structure 128 may be an extension from the expanding structure 126.

The function of the linkage structure 128 is to convert the primarily linear motion of the expanding structure 126 to bending and/or rotation motion. A second function of the linkage structure 128 is to preferably maintain the radial distance 130 between the inner seam 122b and the location of the axis of rotation 132. One or more linkage structures 128 and/or one or more expanding structures 126 may be constructed of a single or multiple types of material. One or more linkage structures 128 and/or one or more expanding structures 126 may be connected and/or bonded via methods including but not limited to thermal bonding, gluing, mechanical fasteners, plasma bonding, pressure bonding, and/or any combination thereof. FIG. 5E is a close-up section view of the linkage structure 128 around the location of the axis of rotation 132, which will be abbreviated to the axis of rotation for simplicity onward. The main elements of the linkage structure include at least one axis of rotation (or pivot) 132, at least one flap 134, at least one bonded end 122c, and at least one gap where no bonding occurs 124a. At least one flap 134 connects the at least one inner seam 122b of the expanding structure 126 to the at least one bonded end 122c of the linkage structure 128. At least one axis of rotation 132 may be located in the general vicinity of the location of the at least one bonded end 122c near the gap where no bonding occurs 124a. At least one flap 134 allows rotation of the expanding structure 126 when being inflated around the general location of the axis of rotation 132 while maintaining the radial distance 130 to be within a certain percentage of the nominal distance defined by the length of the flap 134 when the expanding structure 126 is uninflated. In certain preferred embodiments, a single flap 134 may connect to a single layer of the expanding structure 126. In certain embodiments, a single flap 134 may connect to a plurality of layers of the expanding structure 126. In certain embodiments of the present invention, the radial distance 130, also known as the distance of the flap 134 for each layer of the expanding structure, may be different. In certain embodiments of the present invention, the axis of rotation for each layer may be different and/or the same. Preferably, the bonded inner seam 122b, bonded ends 122c, the at least one flaps 134 of one or more linkage structures 128 and/or the walls 120 and/or bonded walls 122, 122a of one or more expanding structure 126 are made up of a single type of homogeneous material and/or a single type of composite material. The overall advantage of this design is that it does not need an outer strain-limiting layer to prevent the expanding structure 126 from drastically diverging, shifting, and/or moving from the center rotational pathway 136, as seen by the large solid-filled arrow shown in FIG. 5C, which may be the expansion axis Z of the expanding structure 126.

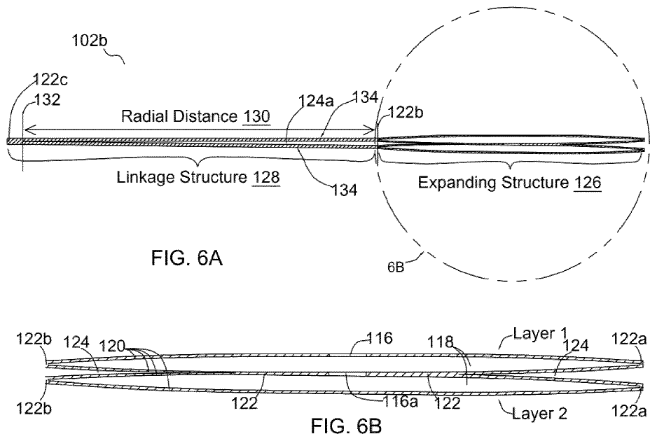

An embodiment of a slightly inflated and/or slightly pressurized 2-layer LLPSFA 102b for providing preferably bending and/or rotation motion, force, and pressure is demonstrated in FIG. 6A. and FIG. 6B. The expanding structure 126 is shown in detail in FIG. 6B. The radial distance 130, which is the distance between the axis of rotation 132 and the bonded inner seam 122b, may increase and/or remain the same when the expanding structure inflates slightly and/or pressurizes slightly. The radial distance 130 may continue to increase and/or remain the same for further inflation and/or pressurization of the expanding structure. The radial distance 130 is part of the linkage structure 128. At least one linkage structure 128 consists of at least one bonded end 122c, at least one axis of rotation 132, at least one gap 124a where no bonding occurs between each layer's linkage structure, and at least one flap 134. At least one bonded end 122c may be the most distal end from the expanding structure. The at least one bonded end 122c may be of any size, thickness, shape, and/or any other form factor. In certain embodiments, the bonded end 122c may not be the most distal end of the expanding structure. In at least some embodiments, a ratio of a width of the layers (i.e., expanding structure 126) of the LLPSFA 102b along the transverse X-axis when in a fully deflated state, to a common length of the flaps 134, which may be the radial distance 130 of the linkage structure 128, is at least 10:1. In other words, in such embodiments, the length of the flaps 134 is 1/10 or less of the width of the fully deflated expanding structure 126. In other embodiments, the ratio is from about 10:1 to about 1:1. In other dimensions, the ratio is at most 1:1. In some embodiments, limiting the common length of the flaps 134 optimizes the effectiveness of the LLPSFA 102b for providing preferably bending and/or rotation motion, force, and pressure. Other relative dimensions are possible and contemplated. One or more flaps 134 may rotate about one or more axes of rotation 132. The expanding structure 126 comprises two layers, but any number of layers may be created based on the embodiments described herein. The expanding structure comprises at least one first layer fluidic inlet 116, one or more subsequent layer fluidic inlets 116a, at least one fluidic pressurization chamber 118, walls for at least one fluidic pressurization chamber 120, bonded walls 122 for integration between two or more expanding structure layers, at least one bonded wall for at least one seam 122a for at least one fluidic pressurization chamber 118, at least one bonded inner seam 122b for at least one fluidic pressurization chamber 118, at least one gap 124 where no bonding occurs separating at least two layers of the expanding structure, Each expanding structure layer connects to at least one flap 134 of the linkage structure via at least one bonded inner seam 122b. The first layer fluidic inlet 116 connects to at least one fluidic tubing, pipe, pathway, and/or any fluid delivery system coming from at least one fluidic control module 200. At least one subsequent layer of fluidic inlets 116a may interconnect each layer's fluidic pressurization chamber 118.

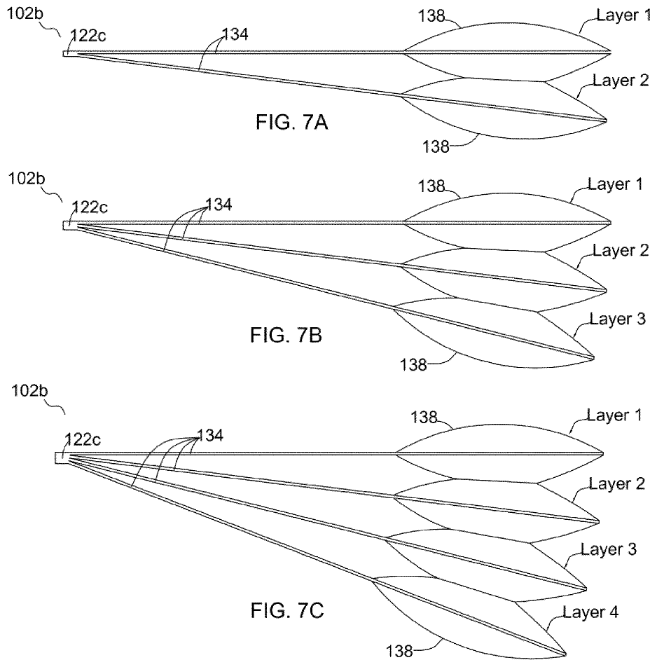

FIG. 7A, FIG. 7B, and FIG. 7C are side perspective views of embodiments of a two-layer, three-layer, and four-layer LLPSFA 102b, respectively, for providing preferably bending and/or rotation motion, force, and pressure. The primary purposes of FIG. 7A to FIG. 7C is to show that LLPSFA may have any number of layers as well as the surfaces 138, 138a available for integration with external components. Although any part and/or surface of the LLPSFA may be used for integration with external components, the outer walls of the first and last layers 138, as well as the bonded ends 122c, may be the best surfaces as they are the most accessible locations of the LLPSFA. The flaps 134 may also be used as integration surfaces with external components. Mechanical, thermal, chemical and any combination thereof may be used for bonding the integration surfaces 138, 122c, 134 with external components. External components may include but are not limited to backing structure 104, attachment mechanism 106, motion mechanism 108, fluidic conduit 110, spring-damper mechanism 112, protective element 114, and sensors.

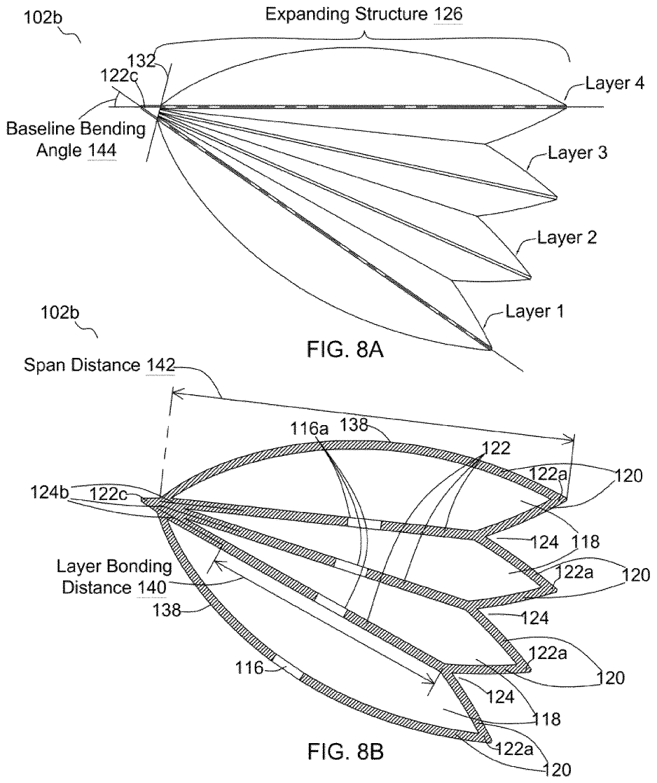

FIG. 8A and FIG. 8B are side perspective views of a preferred embodiment of a four-layer LLPSFA 102b for providing preferably bending and/or rotation motion, force, and pressure. The expanding structure 126 of the embodiment shown in FIG. 8 encompasses most of the volume of the LLPSFA without a linkage structure. At least two layers of the LLPSFA may be bonded and/or connected at the at least one bonded end 122c. The location of the axis of rotation 132 is situated at the inner boundary of the bonded end 122c closest to the at least one inner/proximal gaps 124b as shown by a thicker solid line where no bonding occurs between at least two layers. At least one inner/proximal gap 124b may have no volume due to each layer compressing against neighboring layers. The expanding structure consists of at least one first layer fluidic inlet 116, which connects the first layer's fluidic pressurization chamber 118 to any type of fluidic pathway and/or conduit. At least one fluidic inlet 116a connects each subsequent layer's fluidic chamber 118 with its neighboring layer's fluidic chambers 118. Each layer may be bonded 122 from the inner edge of the outer/distal gap 124 to the inner edge of inner/proximal gap 124b as defined by the layer bonding distance 140. The layer bonding distance 140 may be different for each pair of layers, and as a result, the inner/proximal gap 124b may be different for each pair of layers. Similar to other embodiments of the present invention, the walls 120 are used for bonding, forming fluidic pressurization chambers, and providing structural integrity for the LLPSFA. The walls 120 of each layer may be bonded at the seam 122a forming the outer edge of the outer/distal gap. The outer walls of the first and last layers 138, as well as the bonded ends 122c, may be the best surfaces as they are the most accessible locations of the LLPSFA. The span distance 142 determines the total distance from the bonded seam 122a to the bonded ends 122c. The span distance 142 and the layer bonding distance 140 are two parameters that determine the internal volume of the fluidic pressurization chamber 118 at specific internal pressures, which in turn, determines the baseline bending angle 144 corresponding to a specific internal pressure of the fluidic pressurization chamber. A baseline bending angle 144 is roughly the angle corresponding to the angle between the midline of the top layer, and the midline of the bottom layer about the tip of the bonding ends 122c. The baseline bending angle 144 may range from 0 to 360 degrees. The baseline bending angle 144 may be different from the functional angle when the LLPSFA is attached to other components. In certain embodiments, each fluidic pressurization chamber may be separately controlled and may, therefore, not be interconnected.

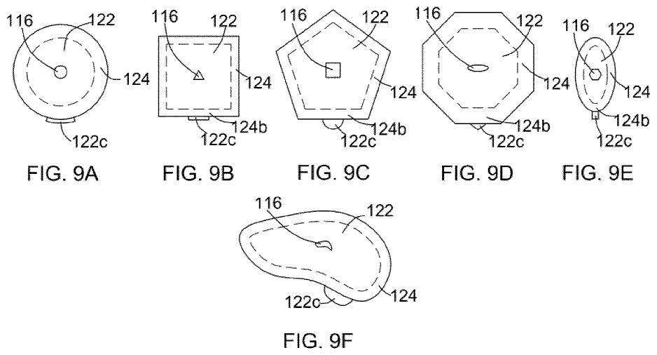

FIG. 9A to FIG. 9E shows the shapes of selective embodiments of an LLPSFA as viewed from the top, which is by no means exhaustive. When viewed from the top, the gaps 124, 124b may become unified and one. Where the open gap 124 transitions to a gap with no space due to compression 124b depends on the baseline bending angle, which in turn depends on the internal pressure of the fluidic pressurization chamber. The first layer fluidic inlet 116 can be seen, and subsequent layer fluidic inlet 116a may be concentric with the first layer fluidic inlet 116. In certain embodiments, the first layer fluidic inlet 116 may not be concentric with the subsequent layer fluidic inlet, and each subsequent layer fluidic inlet may not be concentric with each other. The bonded ends 122c may act as a hinge allowing bending or rotation to occur. The bonded ends 122c may be of any shape, size, geometry, materials, and/or any combination thereof. The first layer fluidic inlet 116 and any subsequent layer fluidic inlet 116a may be of any shape, size, geometry, materials, and/or any combination thereof. The shapes of LLPSFA, as well as any of its subcomponents and/or features, may be random and/or irregular, as seen in FIG. 9F.

An LLPSFA 102 disclosed herein may have a fully depressurized total volume from as small as 1 mm³ to as large as 0.025 m³. However, any total volume outside of 1 mm³ to 0.025 m³ may also be possible. For each one of the fluidic actuator layers, a gap between opposing interior surfaces of the walls may be at most 0.3 mm when the fluidic actuator layer is in a fully deflated state. With reference to FIGS. 2D and 4C, for each one of the fluidic actuator layers, a fully deflated height zi of the fluidic actuator layer (including its walls) along the expansion axis Z may be from 0.02 to 1.5 mm, a fully inflated height z₂ of the fluidic actuator layer along the expansion axis Z may be from 0.4 to 500 mm, a fully deflated width x₁ of the fluidic actuator layer along the transverse axis X may be from 1 to 500 mm, and a fully inflated width x₂ of the fluidic actuator layer along the expansion axis X without elastic stretch may be from 0.99 to 499 mm. For each one of the fluidic actuator layers, a ratio of a fully inflated height z₂ of the fluidic actuator layer along the expansion axis Z when the fluidic actuator layer is in a fully inflated state to a fully deflated height z₁ of the fluidic actuator layer along the expansion axis Z when the fluidic actuator layer is in a fully deflated state may be at least 2:1 and may be as much as 25,000:1. For each one of the fluidic actuator layers, a fully deflated volume of the fluidic pressurization chamber may be at most 75,000 mm³, when the fluidic actuator layer is in a fully deflated state. For each one of the fluidic actuator layers, a ratio of a fully inflated volume of the fluidic pressurization chamber when the fluidic actuator layer in a fully inflated state to a fully deflated volume of the fluidic pressurization chamber when the fluidic actuator layer in a fully deflated state may be at least 2:1. For each one of the fluidic actuator layers, a ratio of a fully inflated width x₂ of the fluidic actuator layer along the transverse axis X when the fluidic actuator layer is in a fully inflated state to a fully deflated width x₂ of the fluidic actuator layer along the transverse axis X when the fluidic actuator layer is in a fully deflated state is at most 1:2. For each one of the fluidic actuator layers, a ratio of a fully deflated height zi of the fluidic actuator layer along the expansion axis Z to a fully deflated width x₁ of the fluidic actuator layer along the transverse axis X when the fluidic actuator layer is in a fully deflated state is at most 1:25,000.

As seen in FIG. 1, the layered low-profile soft fluidic actuators module 100 contains layered low-profile soft fluidic actuators 102, non-limiting embodiments of which are described and explained in depth from FIG. 2 to FIG. 9. Please note that any and all descriptions, parts, aspects, elements, and/or any combination thereof of the layered low-profile soft fluidic actuators 102 may apply to any and all embodiments of the invention described herein. The following descriptions comprise additional components of the layered low-profile soft fluidic actuators module 100 and other modules, including but not limited to backing structure 104, attachment mechanism 106, motion mechanism 108, fluidic conduit 110, spring-damper mechanism 112, and protective element 114. Please note that certain embodiments of the invention presented herein may include any number and any combination of the aforementioned and to-be-mentioned components, and certain embodiments of the invention presented here may include additional components and/or elements not mentioned herein to make a commercially viable system.

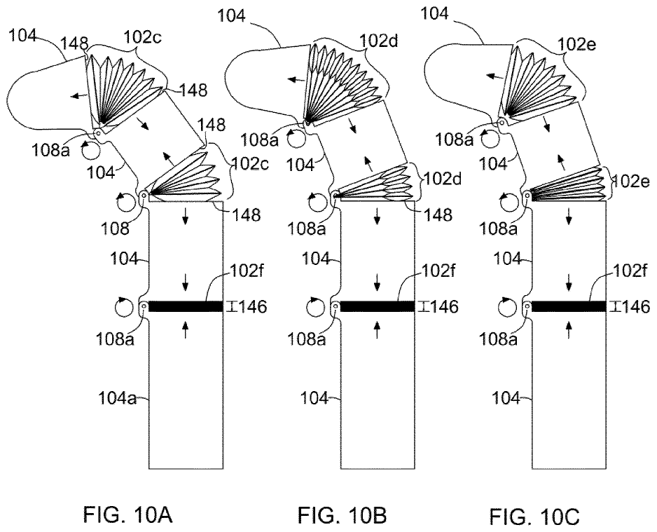

FIG. 10A to FIG. 10C are sides views shows three embodiments of the present invention wherein four backing structures 104 may exist for each embodiment. FIG. 10A to FIG. 10C shows three embodiments of the present invention wherein a single LLPSFA 102c, 102d, 102e may be attached to at least two backing structures 104. In any embodiments of the present invention, any number and/or type of LLPSFA 102 may be attached to any number and/or type of backing structures 104. The backing structures may have any physical properties including but not limited to shape, size, function, make, weight, dimension, and/or volume, and/or may be constructed, made, and/or derived from any type of materials, components, and/or any combination thereof. The LLPSFA 102c shown in FIG. 10A may be similar and/or generally belongs to the same category of LLPSFA 102b that is operable primarily for providing preferably bending and/or rotation motion, force, and pressure as seen in FIG. 8A and FIG. 8B. The LLPSFA 102d shown in FIG. 10A may be similar and/or generally belongs to the same category of LLPSFA 102b that is operable primarily for providing preferably bending and/or rotation motion, force, and pressure as seen in FIG. 5A to FIG. 5E, FIG. 6A, FIG. 6B, and FIG. 7A to FIG. 7C. The LLPSFA 102e shown in FIG. 10A may be similar and/or generally belongs to the same category of LLPSFA 102a that is operable primarily for providing preferably linear motion, force, and/or pressure as seen in FIG. 2A to FIG. 2E, FIG. 3A to FIG. 3C, and FIG. 4A to FIG. 4C. LLPSFA 102e, which is operable primarily for providing preferably linear motion, force, and/or pressure, may be used for embodiments strictly and/or partially meant for preferably bending and/or rotation motion, force, and pressure. Without a protective element 114 and/or bulging prevention and/or strain-limiting cover on the outside surfaces of LLPSFA, they may bulge, which reduces efficiencies of the LLPSFA for producing motion, force, and pressure. LLPSFA 102e may bulge more than LLPSFA 102c, 102d.

As seen in FIG. 10A to FIG. 10C, functionally, LLPSFA may be advantageous compared to alternatives in that when they are fully and/or close to fully depressurized and/or a vacuum and/or negative pressure occurs within the LLPSFA pressurization chamber, they become flat and/or low-profile and produced a pulling force as seen in the direction of the arrows immediately above and below 102f. This is advantageous in applications requiring at particular temporal moments and/or time a pushing force and/or pulling onto at least one surface and/or point 148 on the backing structures 104 while simultaneously requiring a low-profile and/or small gap 146 taken up by a fully and/or close-to fully depressurized LLPSFA. The force-bearing surface and/or point 148 is a location on the backing structure that permanently and/or non-permanently contacts a part of any LLPSFA during any point of its motion and/or pressurization/depressurization/vacuum state. For clarity, all LLPSFA 102c, 102d, 102e shall be represented graphically with corresponding reference 102f. Aesthetically, LLPSFA may fold mostly flat and neatly within, and without sticking and/or protruding out of the general vicinity and/or space of the low-profile and/or small gap 146 between any number of backing structures 104 when fully and/or close to fully depressurized and/or a vacuum is produced within the LLPSFA pressurization chamber. The backing structure may have one or multiple surfaces, which may be of any shape, shape, curvature, footprint, and/or any combination thereof, and any of them may be a force-bearing surface 148. Tubing connecting to each LLPSFA are neglected for clarity, they may be complete and/or partially routed via internal cavities within the backing structure 104 and/or completely and/or partially routed externally of the backing structure 104. The back structure may be one or multiple components and/or elements and may be connected to additional components and/or other backing structures. The connections may include mechanical means, chemical means, permanent means, non-permanent means, and/or any combination thereof.

The motion mechanisms 108a for the embodiments of the present invention, as seen in FIG. 10A to FIG. 10C are for providing preferably bending and/or rotation motion of the backing structures 104 as seen by the circular arrows. The bending and/or rotation motion are fully reversible in both clockwise and counterclockwise directions. Other embodiments of the present include any number of motion mechanisms 108 for providing any type of motion. The motion mechanism 108a may attach, connect and/or mate two or more backing structures 104. In the embodiments shown in FIG. 10A to FIG. 10C, the motion mechanisms are two-piece hinges 108a that connect two backing structures 104, allowing rotation about the axis of rotation at the hinge. As for the embodiment shown in FIG. 10A, wherein the axis of rotation of the LLPSFA 102c is different from the axis of rotation of the motion mechanism 108a. However, in certain embodiments of the present invention, such as the one seen in FIG. 10B, one or more axis of rotation of one or more LLPSFA 102d may align with one or more axis of rotation of one or more motion mechanisms 108a. LLPSFA 102c may produce more bending torque about the axis of rotation of the motion mechanism 108 than LLPSFA 102d as it has more surface area applying the force onto the force-bearing surface 148 of the backing structure 104. The motion mechanism 108 for rotation may be facilitated by hinges, ball bearings, rotational shafts, and/or any mechanical means and/or any combinations thereof. For one or more of the LLPSFAs 102c, 102d, 102e, the corresponding backing structures 104 form an angle with a vertex at the hinge. When the corresponding LLPSFA 102c, 102d, 102e is in a fully deflated state, the angle may be at most 10 degrees, or at most 5 degrees, or at most 1 degree. When the corresponding LLPSFA 102c, 102d, 102e is in a fully inflated state, the angle may be at least 350 degrees, or about 360 degrees, or at least 360 degrees.

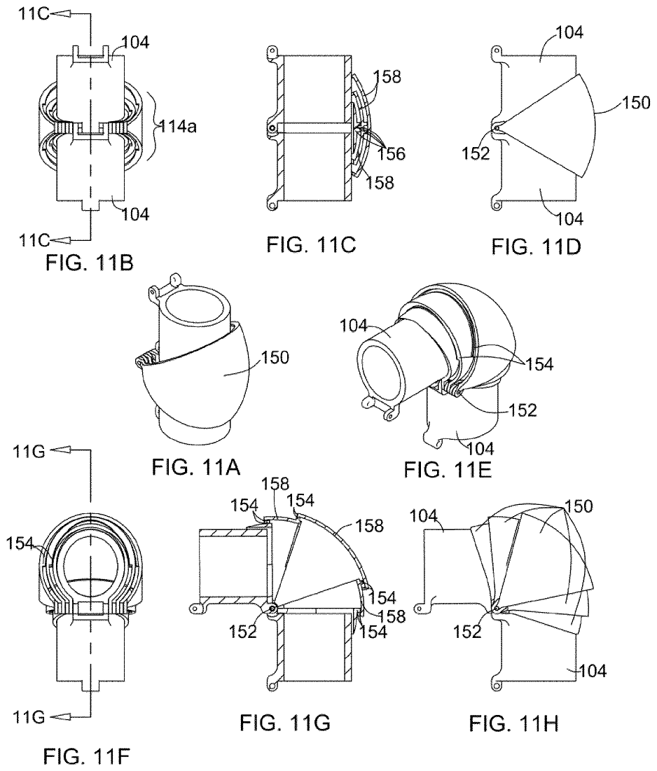

FIG. 11A to FIG. 11H shows an embodiment of the multi-component protective element 114a of the present invention. The LLPSFA is not included in the figures for the purpose of clarity. The multi-component protective element 114a takes inspiration from armadillos, wherein there are multiple protective shells 150, and wherein each protective shell 150 may overlap each other fully and/or partially at any point of the range of motion of the system 000, including but not limited to LLPSFA module 100 and/or other modules and/or sub-components of any module as shown by FIG. 1. One primary and/or preferred function of protective element 114 including but not limited to multi-component protective elements 114a may be protecting one or more LLPSFAs from external forces and elements including but not limited to sharp edges and/or points, impact forces, shear forces, frictional forces, and/or any combination thereof. Protective elements 114 may also comprise protection elements for any sub-components of LLPSFA module 100 and/or other modules and/or sub-components of any module as shown by FIG. 1 of the same. The multi-component protective element 114a and/or its protective shells 150 may be made out of any materials, including but not limited to plastic, elastomers, Kevlar, fabrics, metals, carbon fiber, and/or any composites, and/or any combination thereof. Each protective shell may be made of a different type of material from another. The number, shape, size, location, thickness, curvature, and/or any physical property of protective shells 150 may vary primarily depending on parameters of the LLPSFA, including but not limited to the size, shape, number of layers, wall thickness, location on the backing structure and/or any combination thereof. The number, shape, size, location, thickness, curvature, and/or any physical property of protective shells 150 may additionally vary depending on parameters and/or any physical property of any modules and/or subcomponents of modules of the invention described herein. Certain embodiments of the present invention may not require and/or include protective elements 114.

The embodiment of multi-component protective element 114a, as shown in FIG. 11A to FIG. 11H comprises 5 protective shells. Any number of protective shells may permanently and/or non-permanently attach to any surface and/or points on the backing structure 104 and/or any modules and/or sub-components of any modules of the present invention. To facilitate rotation with the LLPSFA together with the backing structure, the protective shells may be hinged 152 with the same axis of rotation as the backing structure 104 and/or the axis of rotation of any LLPSFA and/or both. In certain embodiments of the present invention, any protective shell 150 may not be hinged 152 with the same axis of rotation as the backing structure 104 and/or any other protective shell 150 and/or any LLPSFA. In certain embodiments of the present invention, any protective shell 150 may not be hinged at all. In preferred embodiments, protective shells 150 are attached permanently and/or non-permanently to the backing structure 104 in some mechanisms, including but not limited to mechanical means and/or chemical means, including mechanical fasteners, hinges, pivots, brackets, glue, tape, and any combination thereof. The rotation of the protective shell 150 may be facilitated by hinges, ball bearings, rotational shafts, and/or any mechanical means and/or any combinations thereof. Any protective shell 150 may have any number of full-span motion limiters 154 and full-retraction motion limiters 156, and protection surface 158. The primary function of full-span motion limiters 154 may be to prevent the protective shells 150 from rotating over the full-span or maximum rotational limit of its protection range of motion and thereby creating gaps between the protective shells 150 and exposing an LLPSFA and/or other sub-components to undesirable and/or unaccounted conditions and forces. The primary function of full-retraction motion limiters 156 may be to prevent the protective shells from rotating over the limit of their protection range of motion when fully retracted and thereby creating gaps between the protective shells 150 and exposing an LLPSFA and/or other sub-components to undesirable and/or unaccounted conditions and forces. Protection surface 158 is the functional entity of the protective element 114 that enables complete and/or partial protection of an LLPSFA and any other sub-components of the invention described herein. The motion limiters 154, 156 may exist as a protruding surface on any location of the protective element 114, preferably, either the outer and/or the inner edge of the protection surface 158 as it maximizes the protection range utilizing close to or the full rotational motion span of the protective shell 150. Two or more motion limiters 154, 156 on two or more separate protective shells 150 may collide and hence non-permanently link the two or more protective shells during retraction and/or rotation toward full span. The non-permanent linking of the two or more protective shells prevents any gaps from forming during the motion of the protective shells 150. When reaching full retraction or full span, the linking of protective shells prevents further motion while maintaining a gap-free geometry and form factor. In practicality, small gaps may exist; however, these small gaps in actual applications do not impede or negatively affect the overall function of the invention described herein and shall be considered acceptable. Full-span motion limiters 154 and full-retraction motion limiters 156 may be the same and/or different structures. The aforementioned features, elements, and embodiments may be used as protective elements for primary linear motion and/or any type of motion.

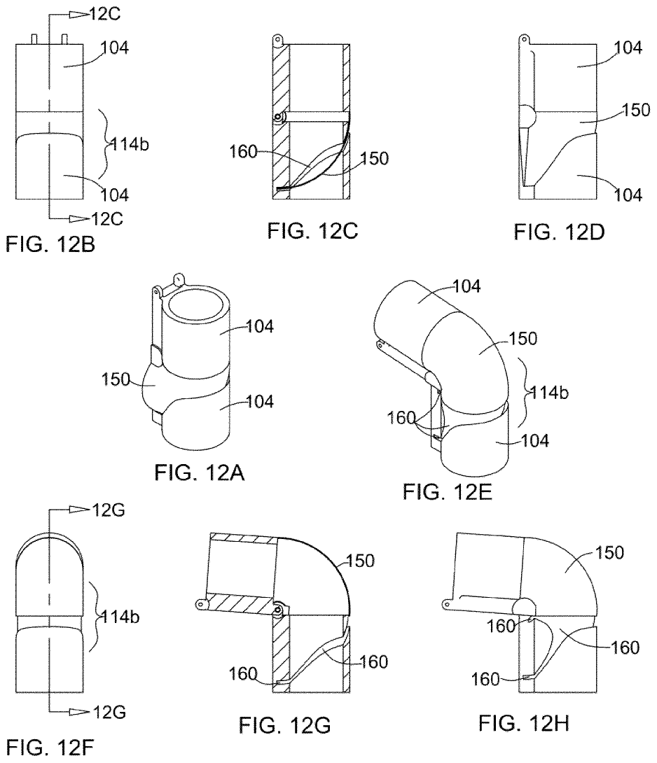

FIG. 12A to FIG. 12H shows an embodiment of a uni-body protective element 114b. In this embodiment, the protective shell 150 is fully integrated as part of the backing structure 104. The LLPSFA is not included in the figures for the purpose of clarity. The protective shell 150 becomes an extension from the backing structure 104. A slot 160 exists on the other backing structure 104 if the LLPSFA is applying forces onto two backing structures 104 as seen in FIG. 12A to FIG. 12H. The slot 160 allows the protective shell 150 to be inserted into. The protective shell 150 travels in and out of the slot 160. The slot 160 is created to have the physical properties including but not limited to tolerance, shape, depth, size, and curvature to accommodate the motion of the protective shell 150 in a manner that should not impede the motion of the protective shell 150 throughout the entire range and/or span of its motion. In the case that there are three or more backing structures 104, each backing structure may have any number of protective shell 150 and/or any number of slot 160 in such a way that any and/or certain protective shell 150 may fit into any and/or certain slot 160. The physical properties, including size, shape, thickness, materials, and curvature of the protective shell 150 depend on the range of motion of the LLPSFA as well as the backing structures as well as the application. In certain embodiments, any number of backing structures may have any number of protective shell 150 and slot 160. Although not shown in FIG. 12A to FIG. 12H, motion limiters may be added to uni-body protective element 114b.

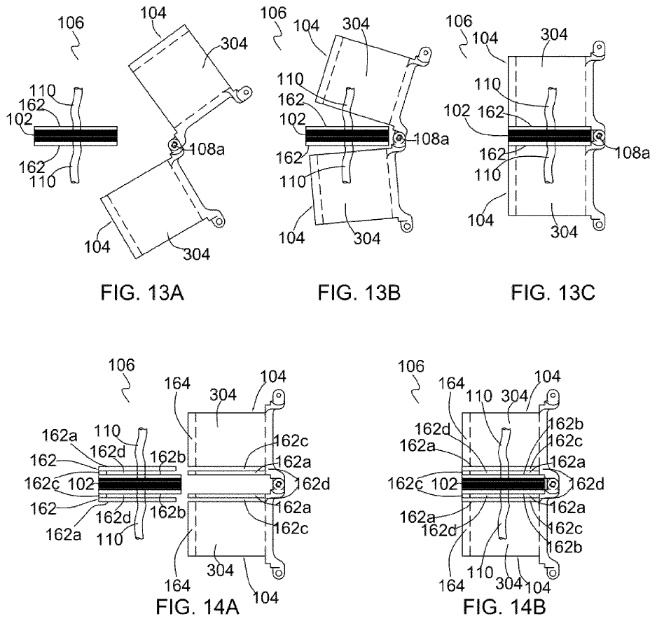

FIG. 13A to FIG. 13C shows the embodiment and/or method of an attachment mechanism 106. Attachment mechanism may allow for ease of attachment of an LLPSFA onto the backing structure. This may exist in certain embodiments of the present invention wherein changing and/or swapping out LLPSFA 102 with a different backing structure 104 and/or vice versa may be desirable. Although the method is shown with an embodiment with a backing structure 104 with a motion mechanism 108 that is primarily for rotation in FIG. 13A to FIG. 13C, the same method may be applied to an embodiment with a backing structure with a motion mechanism that is primarily for linear motion and/or any type of motion and/or combination of motions. One or more modular plate 162 may be attached to one or more surfaces and/or points on the LLPSFA 102. The modular plate 162 may have any physical properties including but not limited to size, shape, thickness, volume, and/or materials. The modular plates may allow one or more allow fluidic conduits 110 to connect to the LLPSFA 102. The modular plate may connect to the LLPSFA 102 via a connection mechanism including but not limited to mechanical fasteners, glue, tape, chemical means, magnetic means, electromagnetic means, squeeze fit, and/or any combination thereof. One or more LLPSFA 102 may connect to one or more modular plate 162. FIG. 13A generally shows the first step in the method of attachment, wherein the backing structures 104 are opened (i.e. rotated to provide an opening large enough about the hinge/motion mechanism 108a so that the entire LLPSFA 102, modular plate 162, and fluidic conduits 110 assembly, which may also include but not limited to any other sub-components of the present invention may be inserted into the opening). FIG. 13B generally shows the second step in the method of attachment, wherein the backing structures begin to close towards the modular plate 162, engulfing and/or enclosing around the fluidic conduits 110 with its internal cavity surrounded by protective surfaces which may serve as fluidic conduit protection element 304. The fluidic conduit protection element 304 may or may not exist in any embodiments of the present invention. FIG. 13C generally shows the third step in the method of attachment, wherein the backing structure 104 mates and/or contacts the modular plates 162 fully and/or partially at one or more surfaces and/or points. The fluidic conduits 110 may be safely enclosed around by the fluidic conduit protection element 304. The purpose of the fluidic conduit protection element 304 may be to protect the fluidic conduits 110 against any unwanted and/or unaccounted elements and/or forces and/or events. Any method of securement may be used permanently and/or semi-permanently and/or non-permanently secure the modular plate 162 to the backing structure 104, including but not limited to mechanical fasteners, magnetic means, electromagnetic means, glue, tapes, squeeze fit, chemical means and/or any combination thereof. Multiple methods and numbers of securement may be used at multiple points and/or surfaces of the attachment mechanism 106. Additional steps may be added and/or any steps may be removed without deviation from the present invention.

FIG. 14A to FIG. 14B shows the embodiment and/or method of another attachment mechanism 106. In this mechanism, the attachment mechanism may not involve opening and/or closing of the backing structure 104. The modular plate 162 may have a minimum of two plates 162a, 162b linked by at least one other structure 162c. The two plates 162a, 162b are separated and therefore create a slot 162d. On the backing structure 104, at least one plate 162a exists and is linked to the rest of the body of the backing structure 104 by at least one linking structure 162d. Between the plate 162a and the rest of the body of the backing structure 104 exist a slot 162c. At least one separate slot and/or gap and/or opening 164 exist on the backing structure 104 to allow at least one fluidic conduit to enter the cavity within the backing structure 104, which serves as fluidic conduit protection 304. One or more modular plate 162 may be attached to one or more surfaces and/or points on the LLPSFA 102. The modular plate 162 may have any physical properties including but not limited to size, shape, thickness, volume, and/or materials. The modular plates 162 may allow one or more allow fluidic conduits 110 to connect to the LLPSFA 102. The plate 162b of the modular plate 162 may connect to the LLPSFA 102 via a connection mechanism including but not limited to mechanical fasteners, glue, tape, chemical means, magnetic means, electromagnetic means, squeeze fit, and/or any combination thereof. One or more LLPSFA 102 may connect to one or more modular plate 162.

FIG. 14A generally shows the first step in the method of attachment, wherein the backing structures 104 may remain at the state where the LLPSFA 102 is fully retracted. The entire LLPSFA 102, modular plate 162, and fluidic conduits 110 assembly, which may also include but not be limited to any other sub-components of the present invention may be inserted into the backing structure 104. FIG. 14B generally shows the second step, wherein the plate 162a of the modular plate 162 is inserted into the slot 162c within the backing structure 104; through the same motion, the plate 162a on the backing structure 104 is inserted into the slot 162c within the same modular plate 162. The plate 162b, which is connected to the LLPSFA 102, becomes connected to the backing structure 104. At least one fluidic conduit enters the fluidic conduit protection cavity 304 through the slot for fluidic conduits 164 through the same inserting motion. A twisting motion may follow the second step that locks and/or latches the modular plates 162 and the backing structure 104 together and/or in place mechanically, hence, making the two the same structure. In certain embodiments, a twisting motion may not be necessary. The methods, including but not limited to mechanical fastening, mechanical latching, chemical means, magnetic means, electromagnetic means, chemical means, glue, tape and combination thereof, may be used to lock and/or fasten the modular plate 162 along with the LLPSFA 102 to the backing structures 104. In both embodiments shown in FIG. 13 and FIG. 14, fluidic conduits 110 may free float and/or be locked down in place without movement and/or very little movement inside the fluidic conduit protection element 304.

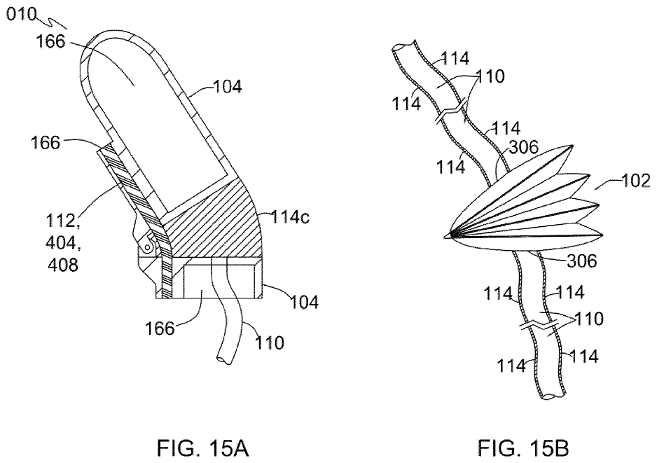

FIG. 15A shows an embodiment of the present invention with a spring-damper mechanism 112 and/or orientation sensors 404 and/or motion sensors 408, as well as a flexible and/or elastic protective element 114c for LLPSFA. For clarity, LLPSFA is not included in FIG. 15A. At least one cavity and/or opening 166 exist within the structure of at least one backing structure 104 allowing the insertion and/or placement of at least one spring-damper mechanism 112 and/or orientation sensors 404 and/or motion sensors 408 and/or any combination thereof. Spring-damper mechanism 112 may allow the system and/or sub-system 010 to return to a neutral state, relaxed state, initial state, fully retracted state, fully extended state, and/or any combination thereof without active pressurization and/or active depressurization and/or active vacuuming of the LLPSFA by using stored spring energy of the spring-damper mechanism 112. In addition, the spring-damper mechanism 112 may allow tuning of the rate of motion of the system 000 and/or sub-system 010. The spring-damper mechanism 112 may traverse and/or connect multiple backing structures 104 and/or LLPSFA and/or any other sub-components and/or modules of the present invention. The orientation sensor 404 detects the relative and/or absolute orientation of the backing structure 104 and/or LLPSFA and/or any other sub-components and/or modules of the present invention relative to at least one or more absolute point, coordinates, and/or datum. The orientation sensor 404 may traverse and/or connect multiple backing structures 104 and/or LLPSFA and/or any other sub-components and/or modules of the present invention. The motion sensor 408 detects motion of the backing structure 104 and/or LLPSFA and/or any other sub-components and/or modules of the present invention. The motion sensor 408 may traverse and/or connect multiple backing structures 104 and/or LLPSFA and/or any other sub-components and/or modules of the present invention. The same cavity 166 may also be used to house and/or route any other number of sub-components, including but not limited to other sensors and/or fluidic conduits 110. Flexible and/or elastic protective element 114c including but not limited to elastomers, thermoplastic materials, thermoset materials, rubber, leather, synthetic leather, silicone, hyper-elastic material, Kevlar, fabric, denim, composite material, and/or any combination thereof may protect LLPSFA and/or any sub-component and/or module of the present invention from unwanted and/or unaccounted forces, events, elements, and/or phenomenon. The flexible and/or elastic protective element 114c may crease, stretch and/or fold partially and/or completely during any type of motion. The flexible and/or elastic protective element 114c may be layered, and each layer may be attached and/or separate and/or have a different type of physical and/or material property. The flexible and/or elastic protective element 114c may attach to at least one backing structure and/or LLPSFA via any method, including but not limited to mechanical fasteners, glue, tape, folds, fabric bonding methods, welds, thermal bonding, UV curing, and any combination thereof.

FIG. 15B shows an embodiment of the present invention wherein the surface-hugging fluidic conduit protection element 304a is demonstrated along with the fluidic conduit connection mechanism 306. The surface-hugging fluidic conduit protection element 304a may be rigid, flexible, and/or elastic. It may be applied onto the surface of a fluidic conduit 110, and/or the fluidic conduit itself may be made from the same. The surface-hugging fluidic conduit protection element 304a may extend the entire length of the underlying fluidic conduit 110, or it may be applied to only a section of the underlying fluidic conduit 110. Different sections of the same fluidic conduit 110 may have the same or different type of surface-hugging fluidic conduit protection element 304a. In certain embodiments of the present invention, the surface-hugging fluidic conduit protection element 304a may not fully and/or partially and/or at all hug the surface but have gaps at certain locations and/or everywhere along the length of the fluidic conduit 302. In certain embodiments of the present invention, a surface-hugging protection element may also be applied to the surface of the LLPSFA. Fluidic conduit connection mechanism 306 may enable permanent and/or non-permanent connections between fluidic conduits, fluidic hardware, any components involving fluid, LLPSFA, and any combination thereof. Fluidic conduit connection mechanism 306 includes but is not limited to fluidic connectors, glue, tape, sealant, thermal bonding methods, UV bonding methods, welds, and any combination thereof.

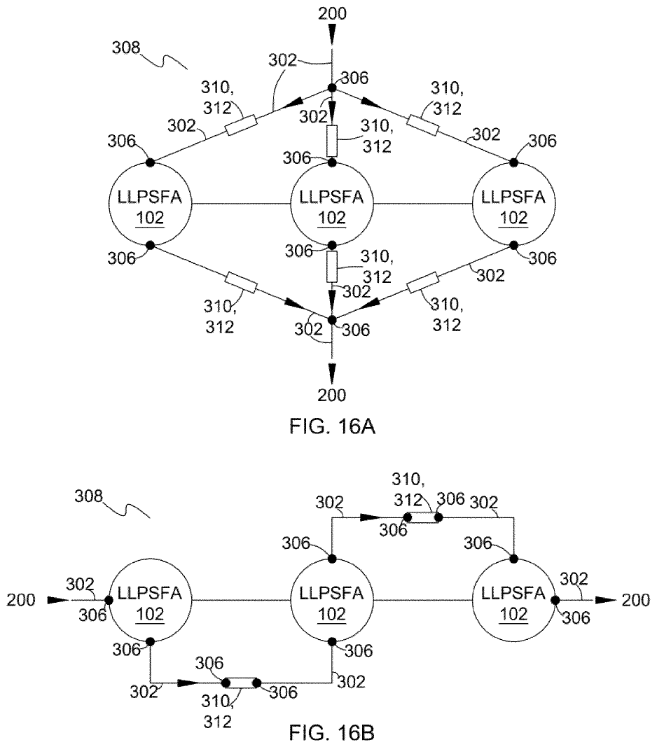

FIG. 16A and FIG. 16B shows a schematic drawing of an embodiment of the present invention describing fluidic distribution mechanisms 308. At least one fluidic distribution mechanism 308 may distribute at least one fluid flow and/or pressure to and/or from at least one fluidic source 202 and/or at least one fluidic control module 200 to any component involving fluid, any LLPSFA 102 and/or external atmosphere/environment and/or any combination thereof. External atmosphere/environment may mean any space that may exist entirely and/or partially of the present invention. Fluidic distribution mechanism may include any number of fluidic resistors 310, fluidic capacitors 312, fluidic conduit 302 and/or fluidic conduit connection mechanism 306. At any point in the fluidic distribution mechanism 308, any component involving fluid may be spliced and/or placed in between any of the aforementioned fluidic components 310, 312, 302. Additional components, modules, and sub-components that may accompany fluidic distribution mechanism 308 may not be included in FIG. 16A, FIG. 16B for clarity. Fluidic resistors 310 may reduce the fluidic flow rate and/or enable fluidic pressure drop across it. Any fluidic resistor 310 may enable different amounts of fluidic pressure drop and/or different amounts of reduction in fluidic flow rate. Physical embodiments of fluidic resistors 310 may include but are not limited to tubing, microchannels, minichannels, passive valves, active valves, microvalves, and/or any combination thereof. Fluidic capacitor 312 may accumulate fluid volume and pressure. Physical embodiments of fluidic capacitors 310 may include but are not limited to tubing, accumulators, balloons, bladders, valves, microvalves, LLPSFA, and/or any soft fluidic actuators. Fluidic conduit 302 transports fluid flow and/or pressure. Physical embodiments of fluidic conduit 302 may include but are not limited to tubing, microchannels, minichannels, passive valves, active valves, microvalves, and/or any combination thereof. In certain embodiments, any combination of fluidic resistors 310, fluidic capacitors 312, and/or fluidic conduits 302, fluidic conduit connection mechanism 306 may be of the same component and/or different components. Fluidic conduit connection mechanism 306 may connect any number and/or combination of fluidic resistor 310, fluidic capacitor 312, fluidic conduit 302, and/or LLPSFA together in any configuration and/or way. The arrows in FIG. 16A and FIG. 16B may suggest some potential directions of fluid flow within the components of the fluidic distribution mechanism 308. The thick line linking LLPSFA together may suggest mechanical linkages and/or additional fluidic distribution mechanism and/or any modules and/or sub-components of the modules of the invention described herein. FIG. 16A may represent a fluidic distribution mechanism with parallel inflows into three LLPSFA and parallel outflows out of the same three LLPSFA. The three inflow pathways may have different fluidic resistance and/or fluidic capacitance to allow sequential and/or uniform pressurization of the three LLPSFA. The three outflow pathways may have different fluidic resistance and/or fluidic capacitance to allow sequential and/or uniform depressurization of the three LLPSFA. The inflow and outflow pathways may be switched. The inflow pathways may also act as outflow pathways. The outflow pathways may also act as inflow pathways. For example, the fluidic pathway with the smallest fluidic resistance and/or fluidic capacitance may allow the connecting LLPSFA to pressurize and/or depressurize and/or become vacuumed the fastest, followed by the LLPSFA connecting to the fluidic pathway with the second smallest fluidic resistance and/or fluidic capacitance, then followed by the third LLPSFA connecting to the fluidic pathway with the third smallest fluidic resistance and/or fluidic capacitance, and continues on until the LLPSFA connecting to the fluidic pathway with the highest fluidic resistance and/or fluidic capacitance. The fluidic resistance and/or fluidic capacitance controls the rate of fluidic flow and pressurization, depressurization, vacuum and/or any combination thereof of the LLPSFA. When the at least two LLPSFA are connected in a fluidic distribution mechanism, at least two LLPSFA may have different pressurization, depressurization, and/or vacuum rate, which determines the motion they may undergo and/or experience and/or torque and/or force they may apply to itself and/or other components including but are not limited to backing structures and/or other LLPSFA.

FIG. 16B may represent a fluidic distribution mechanism with fluidic pathways in series connecting three LLPSFA. In this configuration, fluid may only flow in one of two directions, forward or backward, through the fluidic pathway since all fluidic components are linked and/or connected in series. In this case, LLPSFA may become a fluidic capacitor, fluidic resistor, and/or fluidic conduit. For example, the LLPSFA at the most upstream position may pressurize, depressurize, and/or become vacuumed the fastest, followed by the LLPSFA at the second most upstream position, then followed by the LLPSFA at the third most upstream position, and lastly, the LLPSFA at the most downstream position. The upstream and downstream positions may flip based on the direction of fluid flow. Fluidic capacitance and/or fluidic resistance become strictly additive in this configuration. Different LLPSFA at different upstream and/or downstream will experience different pressurization, depressurization and/or vacuum rate. The method, teachings, knowledge, design, and general know-how described by FIG. 16A and FIG. 16B may be applied to any number and/or combination of LLPSFA 102, flow pathways, and/or fluidic transportation module. Any embodiment of the present invention may use any combination of parallel and/or series flow pathways in any orientation, format, sequence, and/or way.

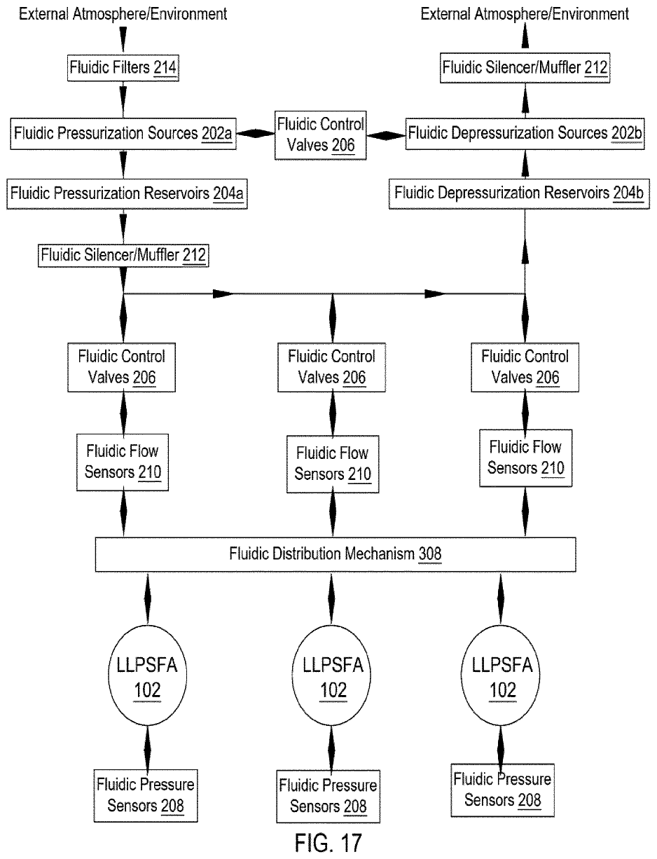

FIG. 17 is a schematic showing fluid pathways/fluidic conduit 302 and/or fluid flow directions in between and/or among various components that may involve fluids of at least one possible embodiment of the present invention. Any components mentioned in the descriptions herein or not may be added and/or removed from FIG. 17 without deviation from the present invention. Any number of any component may exist without deviation from the present invention. The arrows show possible and/or preferred directions of flow without limiting any other direction of flow. The lines connecting various components may represent at least one fluid pathway/fluidic conduit 302. FIG. 17 may show one possible preferred fluid flow direction of certain embodiments regarding upstream and/or downstream from each other. In any embodiment of the present invention, the location of any components may exist upstream and/or downstream of each other. The purpose of FIG. 17 is to show and demonstrate possible generic fluid flow pathways and directions without limiting possible variations of the fluid flow pathways and directions of the invention described herein. Fluidic pressurization sources 202a, including but not limited to pumps, compressors may draw fluid from the external atmosphere/environment through fluidic filters 214 into fluidic pressurization reservoirs 204. Fluidic filters 214 may filter out unwanted substances, particles, elements, and/or things, and/or any combination thereof. In certain embodiments of the present invention, fluidic pressurization sources 202a may not be required to draw fluid from the external atmosphere/environment to produce fluid flow and/or pressure to components downstream from it. Fluidic pressurization reservoirs 204a may retain and/or hold a certain amount of fluid pressure and volume for use at a later point downstream and/or upstream. Downstream from the fluidic pressurization reservoirs, 204a may exist any number of fluidic silencers/mufflers 212 to reduce the sound that the fluid flow may produce. In certain embodiments of the present invention, the LLPSFA 102 may not only need to pressurize but also depressurized and/or become vacuumed; therefore, the fluidic pressurization sources 202a may be able to pressurize, depressurize, and/or produce a vacuum within any LLPSFA 102. In certain embodiments, fluidic pressurization sources 202a may only be responsible for pressurization of the LLPSFA 102, and a fluidic depressurization source 202 may be responsible for the depressurization of LLPSFA 102 and/or producing a vacuum within any LLPSFA 102. Any fluidic pressurization sources 202a and any fluidic depressurization sources 202b may be fluidly connected by any number and/or type of fluidic control valves 206 and/or any components that may allow fluids to flow directly from one another. In certain embodiments of the present invention, the fluidic pressurization sources 202a and fluidic depressurization sources 202b may not be fluidly connected directly. The fluidic depressurization sources 202b may draw fluids through fluidic depressurization reservoirs 204b into fluidic silencer/muffler 212 and into the external atmosphere/environment. In certain embodiments of the present invention, fluidic depressurization reservoirs 204b may have negative pressure and/or vacuum. In certain embodiments of the present invention, fluidic depressurization reservoirs 204b and fluidic pressurization reservoirs 204a may be the same. Downstream from the fluidic silencer/muffler 212 on the pressurization fluid flow pathway or upstream from the fluidic depressurization reservoirs 204 on the depressurization fluid flow pathway may comprise any number of fluidic control valves 206 of any type that controls fluid flow and/or fluid pressure. These fluidic control valves 206 may be placed in parallel fluid communication, series fluid communication, and/or any combination thereof with each other. Connected to the fluidic control valves 206 are fluidic flow sensors 210, which may measure the flow rate of fluid past the fluidic control valves 206. Any number of fluidic control valves 206 may be connected to any number of fluidic flow sensors 210. Connected to the fluidic flow sensors 210 and/or fluidic control valves 206 may be any number of fluidic distribution mechanisms 308. Fluidic distribution mechanism 308 may be fluidly connected to any number and/or any type of LLPSFA 102. Any number of fluidic pressure sensors 208 may fluidly connect to any number of LLPSFA 102. Fluidic pressure sensors 208 and/or fluidic flow sensors 210 may exist anywhere within the fluid flow pathways of any embodiments of the present invention. Fluidic pressure sensors 208 and/or fluid flow sensors 210 may be the same in certain embodiments of the present invention.

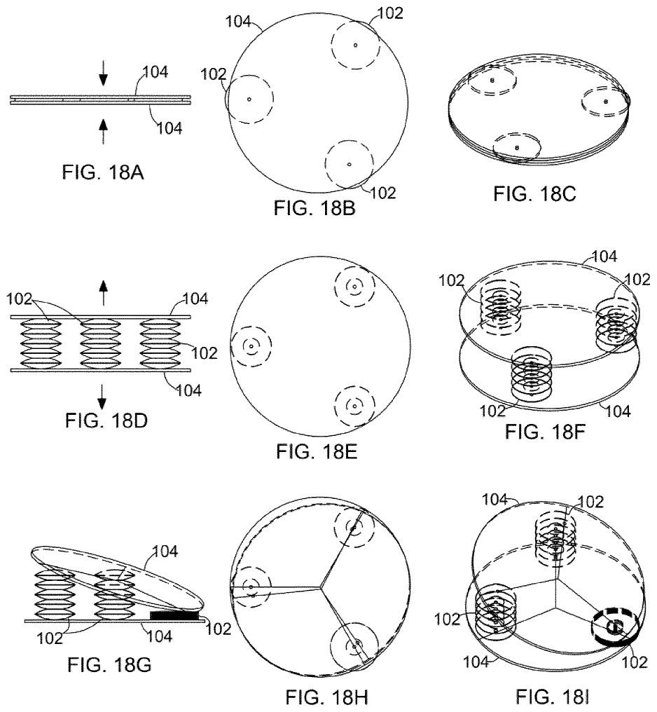

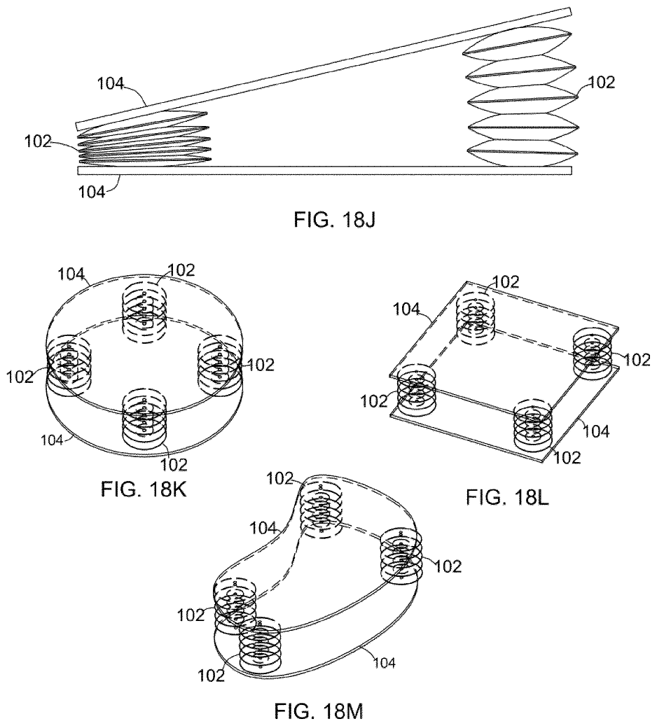

FIG. 18A to FIG. 18M shows various embodiments of the present invention demonstrating multi-degree of freedom (DOF) joint enabled by LLPSFA. The general construction may consist of at least two backing structures 104 and any number of and/or any type of LLPSFA 102 connected to the at least two backing structures 104. The LLPSFA 102 may be placed anywhere between the at least two backing structures 104. The LLPSFA 102 may be permanently, detachably, semi-permanently, and/or freely connected to any number of backing structures 104. The LLPSFA 102 may contact each other at the edges and/or anywhere. The LLPSFA 102 may more preferably be placed some distance apartment from each other. The distance between each LLPSFA 102 may vary. In certain embodiments of the present invention, multiple LLPSFA 102 may be joined and/or connected at the edges, making it a single LLPSFA 102 to allow the same and/or similar type of multi-DOF joint motion. The orientation of the LLPSFA 102 in between the backing structure 104 may be of any orientation, but preferably the direction of motion and/or force applied to the backings structures are directed mostly toward and/or onto the backing structures and not parallel to the backings structures 104, as parallel motion and/or applied force does little to interact with the backing structures 104. The backing structure 104 may be any structure and/or thing that the LLPSFA connects to; however, in certain embodiments of the present invention, a single and/or no backing structure 104 may exist.

For multi-degree freedom joint enabled by LLPSFA 102, the LLPSFA 102 may preferably be placed parallel to each other, as seen in FIG. 18A to FIG. 18M, which will be the general placement and/or orientation for the following description. The LLPSFA 102 may have different physical characteristics, including but not limited to dimensions, layers, size, internal fluidic pressurization chamber volume, wall thickness, and/or any combination thereof. At least one LLPSFA 102 is required to produce linear motion when its fluidic pressurization chamber is pressurized, depressurized, and/or vacuumed. With two LLPSFA 102, as seen in FIG. 18J, a tilting motion along with linear motion may be possible when the fluidic pressurization chamber of either or both LLPSFA 102 is pressurized, depressurized, and/or vacuumed, making it a 2-DOF joint enabled by LLPSFA. The amount of linear motion and/or tilting and the amount of force and/or torque produced and/or imparted onto at least one backing structure 104 may depend on the fluidic pressure within the fluidic pressurization chamber of the LLPSFA 102 and/or the amount of external and/or internal disturbance forces and/or torques applied onto the backing structure 104, LLPSFA 102, any modules and/or sub-components of the present invention, and/or any combination thereof. External disturbances mean any mechanical interaction applied to any embodiments of the present invention not produced by any part of the embodiments of the present invention. Internal disturbances mean any mechanical interaction applied to any embodiments of the present invention produced at least in part by any part of the embodiments of the present invention. When internal and/or external disturbance forces and/or torques are applied onto the backing structure 104, LLPSFA 102, any modules and/or sub-components of the present invention, and/or any combination thereof, the linear motion may be no longer linear, and the tilt motion may no longer follow its initial programmed, partially programmed, and/or unprogrammed trajectory. The tilting motion as seen in FIG. 18J may require the LLPSFA 102 to distort and/or contort in a predictable, semi-predictable, unpredictable, controlled, semi-controlled, and/or uncontrolled manner and/or way. In certain embodiments of the present invention, linear motions may require the LLPSFA 102 to distort and/or contort in a predictable, semi-predictable, unpredictable, controlled, semi-controlled, and/or uncontrolled manner and/or way. FIG. 18A, FIG. 18B, and FIG. 18C shows a three-LLPSFA-enabled multi-DOF joint when all three LLPSFA 102 are fully and/or nearly fully depressurized and/or vacuumed. The arrows in FIG. 18A may represent the direction of the pulling forces acted upon the backing structures 104 by the LLPSFA 102 during depressurization and/or vacuum of the LLPSFA's fluidic pressurization chambers. These pulling forces may be transferred onto any components connected to at least one backing structure 104. One advantage of LLPSFA-enabled multi-DOF joints is that when all the LLPSFA 102 are fully and/or nearly fully depressurized and/or vacuumed, their profile may be very thin, which may prove useful in applications where space is very limited and/or miniaturization is crucial. And because of the thin profile of the LLPSFA 102 when fully and/or nearly fully depressurized and/or vacuumed, many layers may be given to LLPSFA 102, which increase the range of motion produced at a potentially lower pressure and/or vacuum within LLPSFA's fluidic pressurization chamber without sacrificing the low-profile structure of the LLPSFA 102. FIG. 18D to FIG. 18F may show a fully and/or nearly fully pressurized three-LLPSFA multi-DOF joint producing linear motion. It may be seen that the three LLPSFA 102 have, in general, the same physical properties, which may mean but not necessarily that the pressure required within the fluidic pressurization chambers of all three LLPSFA 102 are nearly the same or exactly the same at any point along the trajectory and/or path of the linear motion. In certain embodiments of the present invention, the physical properties of any LLPSFA 102 for a multi-DOF joint may not be the same, in which case, in order to produce a linear motion, the pressure within the fluidic pressurization chamber of each LLPSFA 102 may be different at any point along the trajectory and/or path of the linear motion. FIG. 18G to FIG. 18I shows a three-LLPSFA-enabled multi-DOF joint for a tilting motion wherein two LLPSFA 102 are nearly and/or fully pressurized, whereas the third LLPSFA 102 are nearly and/or fully deflated and/or vacuumed. At least one backing structure 104 would become tilted towards the LLPSFA 102 that is lower in height than the other two LLPSFA 102. In certain embodiments, the lower in height LLPSFA 102 may not be the less pressurized. By changing and varying the height of each LLPSFA 102 by tuning their pressure within their fluidic pressurization chambers, at least one backing structure 104 may tilt in different directions with different amounts of tilting. At least three-LLPSFA-enabled multi-DOF joint may therefore have three degrees of freedom, one for linear motion and two degrees of freedom for tilting motion. The linear motion may be performed exclusively. The tilting motion may be performed exclusively. Linear motion and tilting motion may be performed simultaneously. In certain embodiments of the present invention, distortion and/or contortion of LLPSFA 102 may not be necessary for the at least one backing structure 104 of an LLPSFA-enabled multi-DOF joint to tilt. FIG. 18K to FIG. 18M are embodiments of LLPSFA-enabled multi-DOF joint that have at least four LLPSFA 102 placed at different locations between at least two backing structures 104 of different shapes and/or sizes and/or physical properties. The purpose of FIG. 18K to FIG. 18M is to show that LLPSFA-enabled multi-DOF joints may have any number of LLPSFA 102 placed anywhere in between backing structures. The shape of backing structures 104 may be any shape, including irregular and/or random. Multiple LLPSFA-enabled multi-DOF joints may also be stacked. For instance, the bottom may be a backing structure, followed by a section of LLPSFA, then a back structure, then a section of LLPSFA, then a backing structure, and repeat until the desired number of stacked LLPSFA-enabled multi-DOF joints is achieved. LLPSFA may be inherently compliant, meaning that any internal and/or external disturbances may cause a response to the orientation, force applied, and/or motion of the LLPSFA along with any modules and/or sub-components of the present invention. The LLPSFA's inherent compliance may allow any embodiments of the present invention to handle soft and delicate objects without breaking, bruising, and/or damage. Also, LLPSFA's inherent compliance may allow any embodiments of the present invention to not be damaged and/or only partially damaged when internal and/or external disturbances are acted upon any embodiments of the present invention.

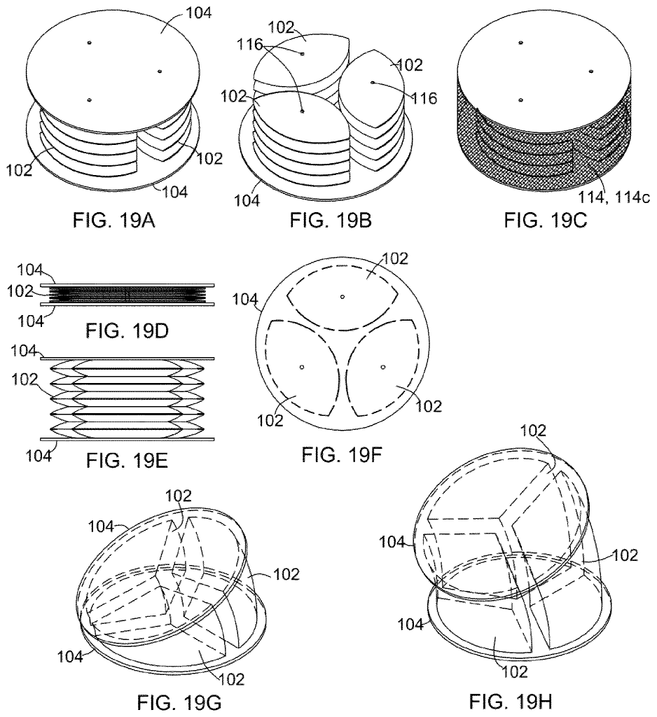

FIG. 19A to FIG. 19H show another embodiment of LLPSFA-enabled multi-DOF joint where the shape of LLPSFA 102 may be different from the embodiment shown in FIG. 18A to FIG. 18M. The embodiments shown in FIG. 19A to FIG. 19H have larger LLPSFA contact surface area to total surface area of backing structure ratios, meaning that the LLPSFA 102 contacts more of the backing structure 104 surfaces, leaving fewer non-contacted surfaces. The advantage of this is due to the larger contact surface area to total surface area of backing structure ratio, the forces applied to the backing structure 104 by the LLPSFA 102 will be relatively larger than LLPSFA—backing structure pairs with the same backing structure but an LLPSFA with a smaller contact surface area to total surface area of backing structure ratio. This way, the LLPSFA—backing structure pair may be more efficient in providing certain forces, torques, and/or motion to anything contacting the LLPSFA—backings structure pair. Another purpose of this embodiment is to show that the LLPSFA 102 of the present invention may have any shape, size, and/or physical properties. As a non-limiting example, the LLPSFA 102 shown in FIGS. 19A-19H is lens-shaped. Any type of protective element 114, but preferable, a flexible and/or elastic protective element 114c may be used to enclose the sides that the LLPSFA 102 may be exposed to any unwanted and/or unaccounted elements and/or forces and/or events as seen in FIG. 19C. In certain embodiments of the present invention, any protective element 114 may be fully and/or partially integrated directly into the material and/or surface of the LLPSFA. Fluidic conduits may be connected to fluidic inlets 116.

FIG. 19G and FIG. 19H may show an embodiment of LLPSFA-enabled multi-DOF joint of the present invention wherein the same and/or close the same degrees and/or amount of tilting of at least one backing structure 104 may be achieved but at different heights and/or orientation of LLPSFA 102. For clarity, LLPSFA are replaced by the general shape of an LLPSFA 102, taking up the same general volume and/or space between two backings structures 104. This is an inherent mechanism and/or property of a multi-DOF prismatic joint, which LLPSFA-enabled multi-DOF joint may achieve.

### iii. Applications

LLPSFA may be used in end-effectors and robotics applications requiring handling of delicate, easily damaged and/or soft things and/or objects. LLPSFA may also work in applications requiring anthropomorphic manipulation and/or mimicking human movement, bodily and/or anatomical motions and/or likeness of humans. LLPSFA may also work in applications requiring close collaboration and/or contact with humans and/or animals and/or plants and/or any organism. LLPSFA may also be used in robotics applications where traversing delicate and/or arduous pathways. LLPSFA may be of any size and scale, from micro to macro.

The invention described herein may be used in industries and/or markets, including but not limited to entertainment, medical devices, assistive devices, robotics, humanoid robotics, fruit and vegetable handling and harvesting, object handling, education, exploration, undersea exploration, space exploration, mimicking motions and movements of an organism, sex toys, haptics, augmented and/or virtual reality, surgical equipment and/or tools, bionics, and, prostheses. Below may be some example embodiments of the present invention related to certain applications of the invention described herein.

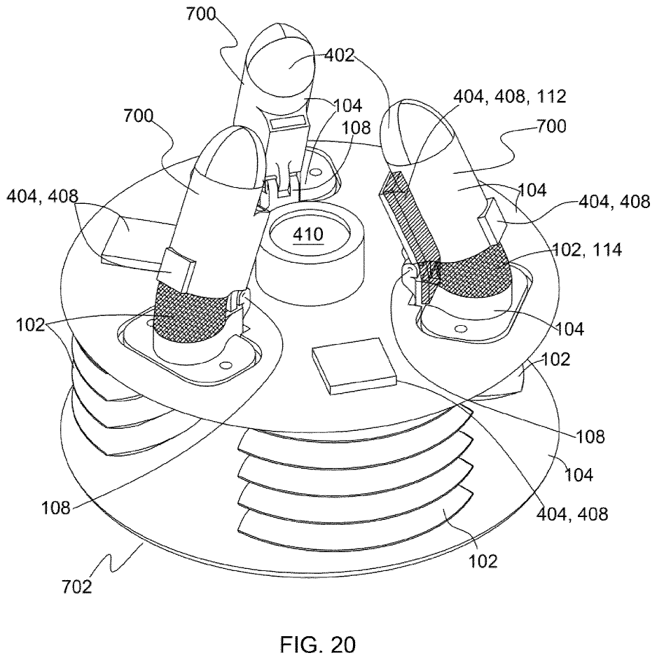

FIG. 20 shows an embodiment of the present invention, which may be used as an end effector for harvesting fruit and/or vegetables and/or handling objects. The embodiment contains three LLPSFA-enabled single-joint manipulators 700, attached permanently and/or partially to an LLPSFA-enabled multi-DOF joint 702. The LLPSFA-enabled single-joint manipulators 700, each may have at least one LLPSFA 102, which may be protected by a protective element 114 of any type. Each LLPSFA 102 for the LLPSFA-enabled single joint manipulator 700 may be attached permanently and/or semi-permanently to at least two backing structures 104. The backing structures may also be connected by a motion mechanism 108, which may but not necessarily be in the form of a primarily rotational motion mechanism in the form of a hinge. Together, the LLPSFA—backing structure—motion mechanism sub-system may but not necessarily produce primarily rotational and/or bending motion, force, and/or torque. Certain points and surfaces, including but not limited to the tip and/or body of the backing structure 104 of the LLPSFA-enabled single-joint manipulator 700, may be used for contacting, handling, gripping objects including but not limited to fruit, vegetables, delicate objects, soft objects, and/or easily-damaged objects. The primarily rotational and/or bending motion, force, and/or torque may allow the LLPSFA-enabled single-joint manipulators 700 to close in and grab and/or grip onto objects and handle and/or manipulate them. The backing structure 104 of the LLPSFA-enabled single-joint manipulator 700 may also contain any number and/or type of sensors, including but not limited to compression force sensors, orientation sensors, biometric sensors, motion sensors, vision sensors, pressure sensors, and/or temperature sensors. Not all sensors are graphically represented in FIG. 20. The sensors may provide information for the control of LLPSFA. The sensors may also allow for the collection of data and information. The backing structure 104 of the LLPSFA-enabled single-joint manipulator 700 may also contain any number and/or type of spring-damper mechanism 112.

The LLPSFA-enabled multi-DOF joint 702 allows prismatic and tilting motion of the embodiment. Prismatic and tilting motion allows the end-effector to be more flexible and effective at handling objects. The LLPSFA-enabled multi-DOF joint 702 may be thought of as the wrist, and the LLPSFA-enabled single-joint manipulator 700 may be thought of as the fingers when compared to a human hand, working synergistically together to most efficiently achieve the goal of handling objects. The backing structure 104 of the LLPSFA-enabled multi-DOF joint 702 may also contain any number and/or type of sensors, including but not limited to compression force sensors, orientation sensors, biometric sensors, motion sensors, vision sensors, pressure sensors, and/or temperature sensors.

Not all sensors are graphically represented in FIG. 20. The sensors may provide information for the control of LLPSFA. The sensors may also allow for the collection of data and information. The backing structure 104 and/or between the backing structures 104 of the LLPSFA-enabled multi-DOF joint 702 may also contain any number and/or type of spring-damper mechanism 112. The location of the sensors may be anywhere on the backing structure 104 for any embodiments of the present invention.

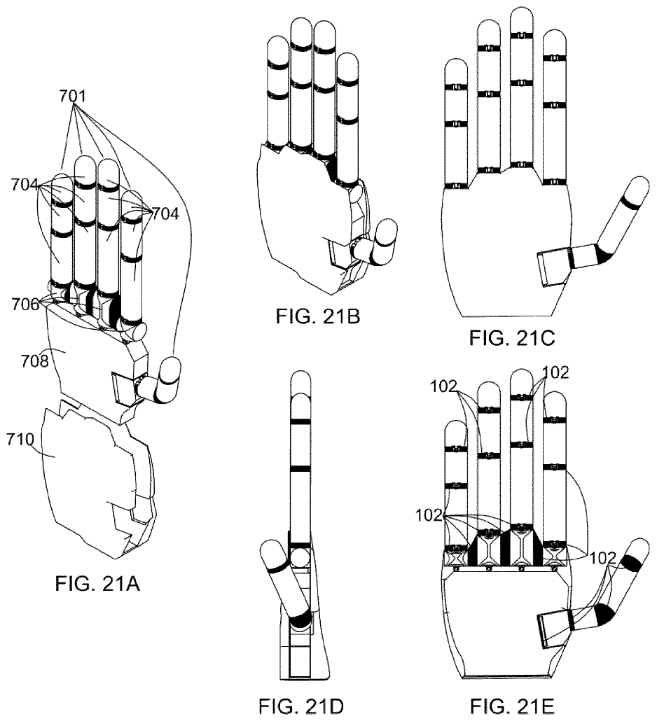

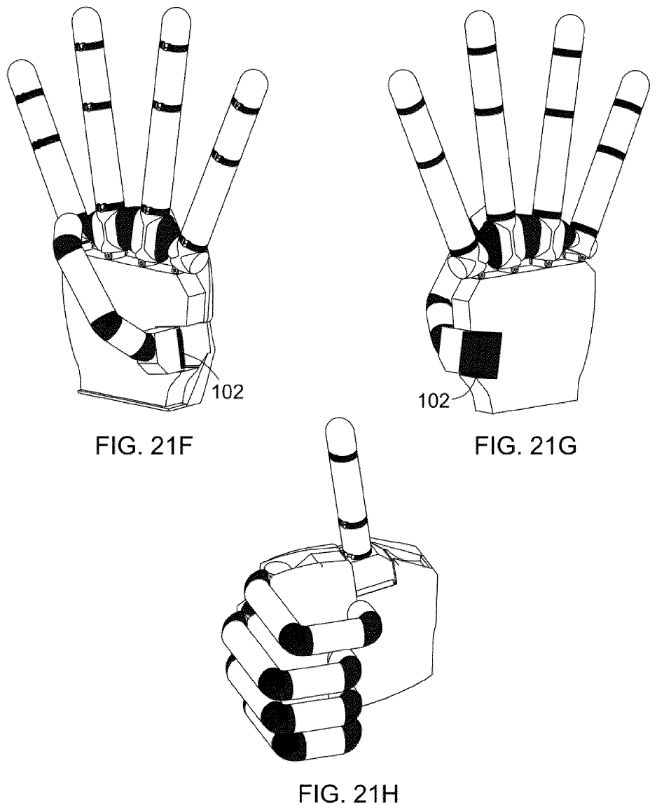

FIG. 21A to FIG. 21H are different views showing an embodiment of the present invention, which may be a robotic end-effector mimicking a human hand. The embodiment contains 5 LLPSFA-enabled multi-joint manipulators 701, and each mimics a particular human finger motion (i.e. thumb, index finger, middle finger, ring finger, and pinky/little finger). LLPSFA-enabled multi-joint manipulators 701 may be made up of components and/or parts including but not limited to backing structures, LLPSFA, motion mechanism, sensors, modules and/or any sub-components of the modules of the present invention. The index, middle, ring, and pinky finger may have full and/or partial flexion/extension of each phalanx 704 and metacarpal 706, which are made possible by at least one LLPSFA 102 at each joint. For clarity purposes, LLPSFA 102 may be replaced by hatched surfaces to represent the approximate location of the LLPSFA 102. The same four fingers may also have full and/or partial abduction and adduction motion made possible by at least one LLPSFA 102 between the metacarpals 706 of each of the same four fingers and/or between the metacarpals and the palm structure 708. The above-mentioned motions make full and/or partial circumduction of each of the same four fingers possible. Four LLPSFA for the thumb makes most of the opposable motion possible, including but not limited to circumduction, flexion, extension, opposition, and/or reposition. Opposition occurs when the tip of the thumb meets/opposes the tip of another finger from the same hand. Reposition is when the thumb and finger return to their original position, which reverses the opposition motion. Abduction and adduction of the thumb may also be possible, although not shown in FIG. 21A to FIG. 21H. At least one palm cover 710 may exist to cover the palm structure 708 to give the palm the natural curvature of a human hand as well as protect a few LLPSFA 102. The palm cover 710 may have any physical and/or material properties. FIG. 21F to FIG. 21H shows some example motions and/or positions of the embodiment of the present invention, which may be a robotic end-effector mimicking a human hand. Certain modules, components, and/or sub-components of modules of the present invention may be neglected in the figures for clarity. Certain embodiments of robotic end-effector mimicking a human hand of the present invention may have a different number of LLPSFA-enabled multi-joint manipulators 701 and/or any number of LLPSFA 102, modules, sub-components of the present invention. The placements and/or locations of LLPSFA-enabled multi-joint manipulators 701, LLPSFA 102, modules, and sub-components of the present may also be different from the embodiments shown. Certain movements and/or motions may be added and/or removed to any embodiments of the present invention.

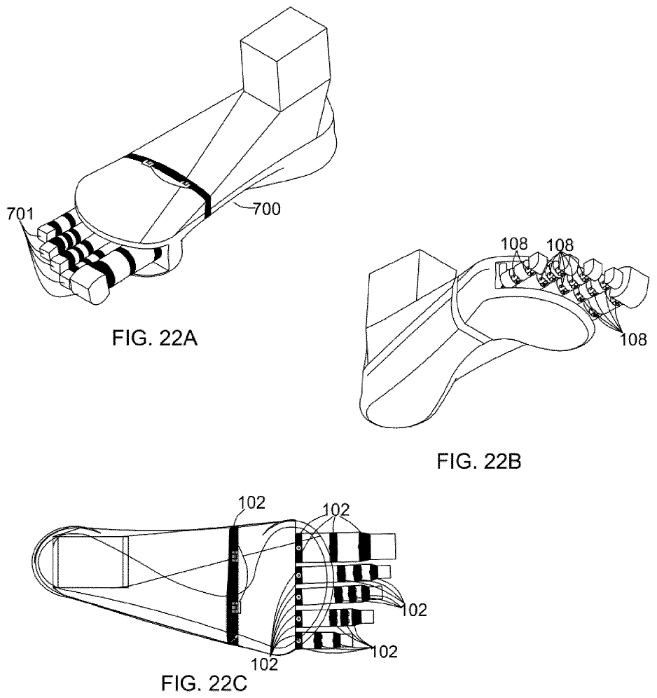

FIG. 22A to FIG. 22C are different views showing an embodiment of the present invention, which may be a robotic system mimicking a human foot. The embodiment may contain 5 LLPSFA-enabled multi-joint manipulators 701 and/or any number of LLPSFA-enabled single-joint manipulators 700, each mimicking a particular human foot digit/toes. For clarity purposes, LLPSFA 102 may be replaced by hatched surfaces to represent the approximate location of the LLPSFA 102. The phalanx of each digit/toe may have full and/or partial flexion and/or extension. The metacarpal and/or of each digit/toes may have full and/or partial abduction and adduction. In certain embodiments of the present invention, movement and/or motions may differ, be added, and/or removed. A cover mimicking and/or representing real human flesh and/or skin may enclose any embodiments of the present invention, preferably the LLPSFA-enabled robotic end-effector mimicking a human, a human hand, and/or any part of a human and/or any organism real and/or fictional. Certain embodiments of robotic robotic system mimicking a human foot of the present invention may have a different number of LLPSFA-enabled multi-joint manipulators 701, LLPSFA-enabled single-joint manipulator 700 and/or any number of LLPSFA 102, modules, sub-components of the present invention. The placements and/or locations of LLPSFA-enabled multi-joint manipulators 701, LLPSFA-enabled single-joint manipulator 700, LLPSFA 102, modules, and sub-components of the present may also be different from the embodiments shown. Certain modules, components, and/or sub-components of modules of the present invention may be neglected in the figures for clarity. In FIG. 22B, the LLPSFA 102 are completely removed in order to show the motion mechanism 108. LLPSFA, along with the motion mechanism 108, may allow the LLPSFA-enabled joint manipulators to mimic motions and/or movements of humans and/or organisms, real and/or fictional. In certain embodiments of the present invention, motion mechanism 108 may not be needed for the entire and/or part of the embodiment.

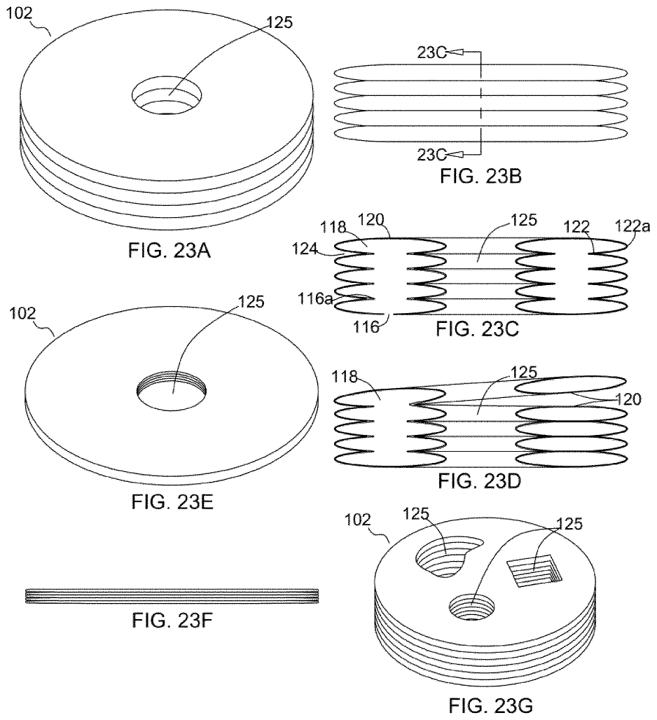

FIG. 23A to FIG. 23G show yet another embodiment of LLPSFA 102 that may share any number of common elements, features, subcomponents or function with any other embodiments of LLPSFA, but with an addition of at least one through-hole 125. The advantage of the through hole is that any type and number of components, including but not limited to backing structures, sensors, cables, straps, wires, struts, and/or protective elements may go through the through-hole 125. Another potential advantage of a LLPSFA 102 with at least one through-hole 125 is that it may remain straight and avoid any buckling during pressurization and/or depressurization and/or vacuuming to create linear actuation when pushing or pulling on a backing structure or any component and/or object. The components that go through the backing structure may be rigid, flexible, elastic, and/or any combination thereof. Any components may also connect and/or be integrated into any part of the walls that make up the through-hole. As seen in FIG. 23G, any number of through-holes 125 of any shape, size and/or volume may exist on any layer of LLPSFA. Any through-hole may or may not go through every layer of the LLPSFA. The through-holes 125 on any layer of LLPSFA may be of different or the same shape and/or size. Each layer of LLPSFA 102 with through-hole 125 may be of any shape and/or size. LLPSFA 102 with through-hole 125 may have any number of layers. Each layer may be fluidly independent (i.e. does not directly communicate fluidly with any other layer) and/or fluidly connected to at least one other layer. As shown by FIG. 23E and FIG. 23F, the LLPSFA 102 with through-hole 125 retains the ability to be low-profile when fully depressurized, partially depressurized, and/or vacuumed. FIG. 23C is a section view of FIG. 23B and shows elements of the LLPSFA 102 with through-hole 125 including but not limited to at least one fluidic pressurization chamber 118, the walls 120 that make up at least one fluidic pressurization chamber, at least one first layer fluidic inlet 116, at least one subsequent layer fluidic inlet 116a, at least one bonded walls for integration 122, at least one bonded walls for at least one seam 122a, at least one gap 124. FIG. 23D is a section view of FIG. 23B with a slight variation where a portion or part of a layer is not connected to at least one neighbouring layer separated by walls 120, which makes a portion of part of a layer freely rotate, allowing LLPSFA with through holes to also produce torque, rotational motion, and/or bending motion.

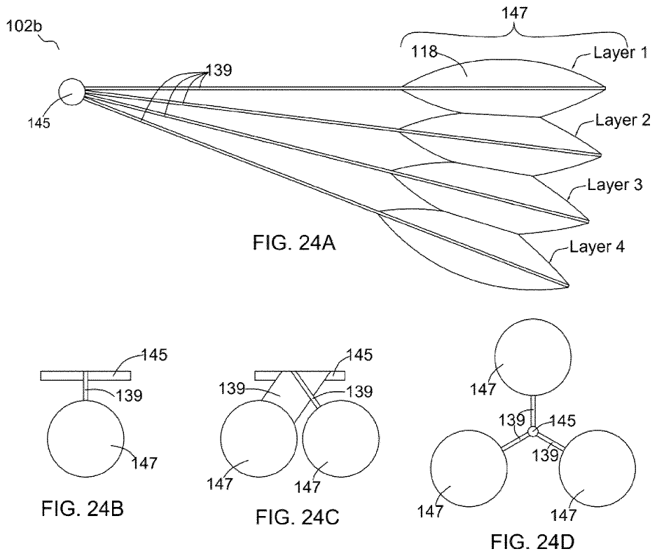

FIG. 24A to FIG. 24D are meant to show yet another embodiment of LLPSFA 102b for providing preferably bending and/or rotational motion, force, and pressure. This embodiment depicted by FIG. 24 may share any number of common elements, features, subcomponents or functions with any other embodiments of LLPSFA, but with additions of at least one tether 139 and/or at least one pivot point (or pivot end) 145. The fluid pressurization chamber 118 may connect to at least one tether, which connects to at least one pivot point 145. The pivot point 145 is the rotation point for one or a plurality of layers of LLPSFA. The tether 139 may be rigid, flexible, and/or elastic. The tether 139 may also be made from any material and/or composite material. The tether 139 may be any shape, size, thickness, and/or width. The pivot point 145 may be rigid, flexible, and/or elastic. The pivot point 145 may also be made from any material and/or composite material. The pivot point 145 may be any shape and/or size and/or have any physical characteristics. For instance, the pivot point 145 may be but is not limited to a hinge, rod, tube, dowel, ball and/or any combination thereof. At least one tether 139 may connect to at least one pivot point 145 through any mechanical method, chemical method, and/or any combination therefore. These connection methods include but are not limited to gluing, taping, welding, squeeze fit, laminating, and/or any combination thereof. Also, at least one tether 139 may be monolithically integrated with at least one pivot point 145. At least one tether 139 may also be connected to at least one other tether 139 before connecting to the pivot point 145. The connection between at least one tether 139 and the at least one pivot point 145 permanently, semi-permanently, and/or detachable. At least one tether 139 may wrap around at least one pivot point 145 and/or a portion/part of at least one pivot point 145 and tie and/or connect back to itself permanently, semi-permanently and/or detachably. As seen in FIG. 24B, at least one tether 139 may connect to at least one pivot point 145 orthogonally and/or on an angle (i.e. not 90 degrees) as seen in FIG. 24C. Each stack 147 may consist of any number of layers and/or types of LLPSFA. At least one tether 139 for each stack 147 may intersect at least one other tether 139 of another stack 147, as shown in FIG. 24C, or not as shown in FIG. 24D. One or a plurality of stacks 147 may connect to a single or a plurality of pivot points 145. At least one pivot point 145 may be independent and/or part of another component including but not limited to a backing structure, protective element, motion mechanism, attachment mechanism, and/or any subcomponents and/or modules of the invention presented herein. At least one pivot point 145 may be permanently, semi-permanently, and/or detachably connected to another component. One advantage of a tethered system may be that it prevents buckling of LLPSFA 102b during rotational motion. Another advantage of a tethered system may be that it prevents outward bulging of LLPSFA 102b during rotational motion.

Please note that any embodiments of LLPSFA mentioned herein may also function as a sensor. The sensors may measure linear displacement distance and/or rotational angle. The measurement may be based on the internal fluidic pressure of the LLPSFA, which may correspond to displacement, distance, and/or angle data. The pressurization and/or depressurization rate of the internal fluidic pressure of the LLPSFA may also correlate to the rate of linear motion/movement and/or rotational speed. LLPSFA may independently act as a sensor or be used with or integrated with other components as a sensor or part of a sensor. Any other modules and/or subcomponents described herein may also be part of LLPSFA when used as a sensor. In certain embodiments of the present invention. LLPSFA may function tandemly and/or simultaneously as a sensor and actuator.

The following are non-limited embodiments of the subject-matter disclosed herein.

Embodiment 1. A fluidic actuator comprising: a plurality of fluidic actuator layers, each fluidic actuator layer comprising: two walls bonded together at a common periphery to form a seam and to define therebetween a sealed fluidic pressurization chamber, wherein each wall is a sheet of flexible and/or elastic material; and a fluid inlet in at least one of the walls providing fluidic access to the sealed fluidic pressurization chamber; wherein: one of the plurality of fluidic actuator layers is an end fluidic actuator layer; the end fluidic actuator layer has an outer fluid inlet in an outer wall of end fluidic actuator layer; the outer fluid inlet of the end fluidic actuator layer provides fluidic access outside of the fluidic actuator to the sealed fluidic pressurization chamber of the end fluidic actuator layer; the fluidic actuator has an expansion axis and a transverse axis orthogonal to the expansion axis, wherein the expansion axis is orthogonal to a plane of the walls of the fluidic actuator layers when the fluidic actuator is in a fully deflated state; and for each one of the fluidic actuator layers, a ratio of a fully inflated height of the fluidic actuator layer along the expansion axis when the fluidic actuator layer is in a fully inflated state to a fully deflated height of the fluidic actuator layer along the expansion axis when the fluidic actuator layer is in a fully deflated state is at least 2:1.

Embodiment 2. The fluidic actuator of Embodiment 1, wherein:

for each one of the fluidic actuator layers, a gap between opposing interior surfaces of the walls along the expansion axis is at most 0.3 mm when the fluidic actuator layer is in the fully deflated state.

Embodiment 3. The fluidic actuator of Embodiment 1 or 2, wherein: for each one of the fluidic actuator layers, the ratio of the fully inflated height of the fluidic actuator layer along the expansion axis when the fluidic actuator layer is in the fully inflated state to the fully deflated height of the fluidic actuator layer along the expansion axis when the fluidic actuator layer is in the fully deflated state is at most 25,000:1.

Embodiment 4. The fluidic actuator of any one of Embodiments 1 to 3, wherein: for each one of the fluidic actuator layers, a fully deflated volume of the fluidic pressurization chamber is at most 75,000 mm³ when the fluidic actuator layer is in the fully deflated state.

Embodiment 5. The fluidic actuator of any one of Embodiments 1 to 4, wherein: a total deflated volume of the fluidic actuator layers is at most 0.025 m³ when the fluidic actuator is in the fully deflated state.

Embodiment 6. The fluidic actuator of any one of Embodiments 1 to 5, wherein: for each one of the fluidic actuator layers, a ratio of a fully inflated volume of the fluidic pressurization chamber when the fluidic actuator layer in the fully inflated state to a fully deflated volume of the fluidic pressurization chamber when the fluidic actuator layer in the fully deflated state is at least 2:1.

Embodiment 7. The fluidic actuator of any one of Embodiments 1 to 6, wherein: for each one of the fluidic actuator layers, a ratio of a fully inflated width of the fluidic actuator layer along the transverse axis when the fluidic actuator layer is in the fully inflated state to a fully deflated width of the fluidic actuator layer along the transverse axis when the fluidic actuator layer is in the fully deflated state is at most 1:2.

Embodiment 8. The fluidic actuator of any one of Embodiments 1 to 7, wherein: for each one of the fluidic actuator layers, a ratio of a fully deflated height of the fluidic actuator layer along the expansion axis to a fully deflated width of the fluidic actuator layer along the transverse axis when the fluidic actuator layer is in the fully deflated state is at most 1:25,000.

Embodiment 9. The fluidic actuator of any one of Embodiments 1 to 8, wherein: respective fluid inlets of adjacent pairs of the plurality of fluidic actuator layers provide fluidic access between the respectively corresponding sealed fluidic pressurization chambers.

Embodiment 10. The fluidic actuator of any one of Embodiments 1 to 9, wherein: the inner fluid inlet of the end fluidic actuator layer provides fluidic access between the sealed fluidic pressurization chamber of the end fluidic actuator layer and the sealed fluidic pressurization chamber of an adjacent one of the fluidic actuator layers.

Embodiment 11. The fluidic actuator of any one of Embodiments 1 to 10, wherein: abutting walls of adjacent pairs of the fluidic actuator layers are bonded together less than an entire width along the transverse axis of the corresponding fluidic actuator layers so as to form gaps between the respective peripheries of the corresponding fluidic actuator layers; and a ratio of a fully inflated gap between the respective peripheries of the corresponding fluidic actuator layers when in the fully inflated state to a fully deflated gap between the respective peripheries of the corresponding fluidic actuator layers when in the fully deflated state is at least 10:1.

Embodiment 12. The fluidic actuator of any one of Embodiments 1 to 11, wherein: at least two of the plurality of the fluidic actuator layers are pivoting fluidic actuator layers; a pivot is hingedly or bendingly coupled to the pivoting actuator layers; and inflation or deflation of at least one of the fluidic actuator layers causes relative rotation between at least some of the fluidic actuator layers about the pivot.

Embodiment 13. The fluidic actuator of Embodiment 12, wherein: the pivot is at respective pivot ends at the peripheries of the pivoting fluidic actuator layers hingedly or bendingly connected at the respective pivot ends.

Embodiment 14. The fluidic actuator of Embodiment 12, wherein: each of the pivoting fluidic actuator layers is connected to a corresponding tether; and the tethers are connected at the pivot.

Embodiment 15. The fluidic actuator of Embodiment 14, wherein: each tether is a rod, a sheet, a film, a tube, or a dowel.

Embodiment 16. The fluidic actuator of any one of Embodiments 12 to 15, wherein: the pivot is a hinge or a ball joint.

Embodiment 17. The fluidic actuator of Embodiment 12, further comprising: a linkage structure comprising: for each of the pivoting fluidic actuator layers, a pivot flap connected at an actuator end thereof to the periphery of the corresponding pivoting fluidic actuator layer; wherein: the pivot is at hingedly or bendingly connected pivot ends of the respective pivot flaps of the pivoting fluidic actuator layers.

Embodiment 18. The fluidic actuator of Embodiment 17, wherein each pivot flap is a sheet of flexible or elastic material.

Embodiment 19. The fluidic actuator of Embodiment 17 or 18, wherein a ratio of a common length of the pivot flaps to a common fully deflated width of the pivoting fluidic actuator layers when in a fully deflated state is at least 1:10.

Embodiment 20. The fluidic actuator of any one of Embodiments 1 to 19, wherein the walls of the fluidic actuator layers are circular.

Embodiment 21. The fluidic actuator of any one of Embodiments 1 to 19, wherein the walls of the fluidic actuator layers are lens-shaped.

Embodiment 22. The fluidic actuator of any one of Embodiments 1 to 21, wherein a cross-section of a fluidic actuator layer in a plane coincident with the expansion axis is lens-shaped.

Embodiment 23. A fluidic actuator device comprising: at least one fluidic actuator as defined in any one of Embodiments 1 to 22; for each fluidic actuator: a corresponding pair of backing structures coupled at opposite ends of the fluidic actuator; and at least one fluidic conduit coupled to the outer fluid inlet of the fluidic actuator.

Embodiment 24. The fluidic actuator device of Embodiment 23, wherein: at least one of the at least one fluidic actuator is a bending fluidic actuator; the two backing structures corresponding to the bending fluidic actuator are pivotably coupled by a hinge at respective peripheries of the two backing structures; and inflation or deflation of the bending fluidic actuator causes relative rotation of the two backing structures about the hinge.

Embodiment 25. The fluidic actuator device of Embodiment 24, wherein: the two backing structures corresponding to the bending fluidic actuator form an angle with a vertex at the hinge; and when the bending fluidic actuator is in the fully deflated state, the angle is at most 10 degrees.

Embodiment 26. The fluidic actuator device of Embodiment 25, wherein: when the bending fluidic actuator is in the fully inflated state, the angle is at least 350 degrees.

Embodiment 27. The fluidic actuator device of any one of Embodiments 24 to 26, further comprising: a spring-damper mechanism coupled to the pair of backing structures at or proximal the hinge, and operative to urge the pair of backing structures to a baseline state.

Embodiment 28. The fluidic actuator device of any one of Embodiments 24 to 27, further comprising, for at least one of the at least one fluidic actuator: at least one protective element comprising at least one protective shell coupled with or proximal the pair of backing structures to protect the fluidic actuator throughout a full range of motion of the backing structures between a fully inflated state and a fully deflated state of the fluidic actuator.

Embodiment 29. The fluidic actuator device of Embodiment 28, wherein: the plurality of protective shells are hinged for common rotation with at least some of the backing structures.

Embodiment 30. The fluidic actuator device of Embodiment 28 or 29, wherein: the protective shells comprise motion limiters mutually operative to prevent relative rotation of the protective shells to create gaps between the protective shells.

Embodiment 31. The fluidic actuator device of any one of Embodiments 24 to 30, further comprising, for at least one of the at least one fluidic actuator: two modular plates respectively coupled at the opposite ends of the fluidic actuator; a pair of securement devices respectively; wherein: the securement devices and the modular plates are respectively positioned for securely mating respectively corresponding pairs of the securement devices and the modular plates for securely coupling the fluid actuator with the pair of backing structures.

Embodiment 32. The fluidic actuator device of Embodiment 31, wherein: the two securement devices comprise mechanical fasteners, touch fasteners, magnetic detents, electromagnetic detents, glue, tapes, squeeze fit couplings, chemical means and/or any combination thereof.

Embodiment 33. The fluidic actuator device of Embodiment 31 or 32, wherein: for the at least one of the at least one fluidic actuator, each of the corresponding pair of backing structures comprises a slot sized and shaped to slidingly receive a corresponding one of the two modular plates to couple the fluidic actuator to the pair of backing structures.

Embodiment 34. A multi-degree-of-freedom joint comprising: a plurality of fluidic actuators each as defined in any one of Embodiments 1 to 22; a pair of backing structures coupled at corresponding opposite ends of the fluidic actuators; and fluidic conduits respectively coupled to the outer fluid inlets of the fluidic actuators.

Embodiment 35. The multi-degree-of-freedom joint of Embodiment 34, wherein: each fluidic actuator is independently inflatable to a corresponding inflation state thereby to selective space the pair of backing structures by a selected spacing and to relatively orient the pair of backing structures by a selected relative tilt between the pair of backing structures.

Embodiment 36. The multi-degree-of-freedom joint of Embodiment 34, wherein: the pair of backing structures define respective through-holes; the through-holes are axially aligned when the fluidic actuators are fully deflated; and the fluidic actuators are respectively positioned such that a passage extending between the through-holes is unobstructed.

Embodiment 37. The multi-degree-of-freedom joint of Embodiment 36, wherein: the through-holes and the fluidic actuators are relatively positioned such that the walls of at least some of the fluidic actuators facing the passage further define the passage extending between the through-holes.

Embodiment 38. An end-effector for harvesting fruit and/or vegetables, comprising: a multi-degree-of-freedom joint as defined in any one of Embodiments 34 to 37; and a set of at least three single-joint manipulators, wherein each single-joint manipulator is a fluidic actuator device as defined in any one of Embodiments 24 to 33 having a single fluidic actuator; wherein: one of the backing structures of the multi-degree-of-freedom joint is an effector mounting base; the set of single-joint manipulators is mounted at respective base ends thereof to the effector mounting base; and at least some of the single-joint manipulators are oriented to bring together respective tips thereof when the respectively corresponding fluidic actuators are inflated, and to separate the respective tips thereof when the respectively corresponding fluidic actuators are deflated.

Embodiment 39. The end-effector of Embodiment 38, further comprising: a vision sensor mounted on the effector mounting base and oriented to view the respective tips of the single-joint manipulators.

Embodiment 40. The end-effector of Embodiment 39, further comprising: at least one of a compression force sensor, an orientation sensor, a biometric sensor, a motion sensor, a proximity sensor, a pressure sensor, a temperature sensor, and/or any combination thereof.

Embodiment 41. A robotic hand comprising: a robotic thumb comprising a fluidic actuator device as defined in any one of Embodiments 24 to 33, wherein each bending fluidic actuator is a thumb joint; a plurality of robotic fingers each comprising a fluidic actuator device as defined in any one of Embodiments 24 to 33, wherein each bending fluidic actuator is a finger joint; and a palm structure, wherein each of the robotic thumb and the robotic fingers is mounted to the palm structure by a hand joint, wherein each hand joint comprises a fluidic actuator device as defined in any one of Embodiments 24 to 33.

Embodiment 42. The robotic hand of Embodiment 41, wherein: at least one of the thumb joints, the finger joints, and/or the hand joints is configured for selective abduction, adduction, and/or circumduction of the corresponding robotic thumb or robotic finger.

Embodiment 43. A robotic foot comprising: a plurality of robotic toes each comprising a fluidic actuator device as defined in any one of Embodiments 24 to 33, wherein each bending fluidic actuator is a toe joint; and a foot body, wherein each robotic toe is mounted to the foot body by a foot joint, wherein each foot joint comprises a fluidic actuator device as defined in any one of Embodiments 24 to 33.

Embodiment 44. A system comprising: a layered low-profile soft fluidic actuators module comprising at least one fluidic actuator device as defined in any one of Embodiments 23 to 33; and a fluidic transportation module comprising at least one fluidic conduit coupled with the actuators module and operative to provide fluidic flow to the at least one fluidic actuator device.

Embodiment 45. The system of Embodiment 44, further comprising: a fluidic control module coupled with the fluidic transportation module and operative to provide fluidic flow to the actuators module via the fluidic transportation module.

Embodiment 46. The system of Embodiment 45, further comprising: a sensors module coupled with at least one of the actuators module and the fluidic transportation module to sense fluidic flow and/or fluidic pressure in the at least one of the actuators module and the fluidic transportation module; a control center module coupled with the sensors module and the fluidic control module and operative to operate the fluidic control module to control the fluidic flow and/or fluidic pressure in the at least one of the actuators module and the fluidic transportation module based on the fluidic flow and/or fluidic pressure sensed by the sensors module; and an electrical power module coupled to provide electrical power to at least one of the fluidic control module, the sensors module, and the control center module.

It must be noted that certain embodiments may have all of the elements described here, whereas certain other embodiments may have only part of the elements described herein. Any elements, features, and/or components described in one embodiment may be used and/or appear in another embodiment of the invention described herein without limitation to produce a commercially viable version of the present invention. Any elements, features, and/or components described may be taken away from one embodiment of the invention described herein without limitation to produce a commercially viable version of the present invention. A person skilled in the art can faithfully reproduce any of the embodiments of the invention described herein.

The invention is contemplated for use in association with layered low-profile soft fluidic actuator devices and methods to afford increased advantageous utilities in association with the same. The invention, however, is not so limited and can be readily used with other items to afford various advantageous utilities within the scope of the invention. Other embodiments, which fall within the scope of the invention, may be provided.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of this patent application and any divisional and/or continuation applications stemming from this patent application.

1. A fluidic actuator comprising:
a plurality of fluidic actuator layers, each fluidic actuator layer comprising:
two walls bonded together at a common periphery to form a seam and to define therebetween a sealed fluidic pressurization chamber, wherein each wall is a sheet of flexible and/or elastic material; and
a fluid inlet in at least one of the walls providing fluidic access to the sealed fluidic pressurization chamber;
wherein:
one of the plurality of fluidic actuator layers is an end fluidic actuator layer;
the end fluidic actuator layer has an outer fluid inlet in an outer wall of end fluidic actuator layer;
the outer fluid inlet of the end fluidic actuator layer provides fluidic access outside of the fluidic actuator to the sealed fluidic pressurization chamber of the end fluidic actuator layer;
the fluidic actuator has an expansion axis and a transverse axis orthogonal to the expansion axis, wherein the expansion axis is orthogonal to a plane of the walls of the fluidic actuator layers when the fluidic actuator is in a fully deflated state; and
for each one of the fluidic actuator layers, a ratio of a fully inflated height of the fluidic actuator layer along the expansion axis when the fluidic actuator layer is in a fully inflated state to a fully deflated height of the fluidic actuator layer along the expansion axis when the fluidic actuator layer is in a fully deflated state is at least 2:1.

2. The fluidic actuator of claim 1, wherein:
for each one of the fluidic actuator layers, a gap between opposing interior surfaces of the walls along the expansion axis is at most 0.3 mm when the fluidic actuator layer is in the fully deflated state.

3. The fluidic actuator of claim 1, wherein:
for each one of the fluidic actuator layers, the ratio of the fully inflated height of the fluidic actuator layer along the expansion axis when the fluidic actuator layer is in the fully inflated state to the fully deflated height of the fluidic actuator layer along the expansion axis when the fluidic actuator layer is in the fully deflated state is at most 25,000:1.

4. The fluidic actuator of claim 1, wherein:
for each one of the fluidic actuator layers, a fully deflated volume of the fluidic pressurization chamber is at most 75,000 mm³ when the fluidic actuator layer is in the fully deflated state.

5. The fluidic actuator of claim 1, wherein:
a total deflated volume of the fluidic actuator layers is at most 0.025 m³ when the fluidic actuator is in the fully deflated state.

6. The fluidic actuator of claim 1, wherein:
for each one of the fluidic actuator layers, a ratio of a fully inflated volume of the fluidic pressurization chamber when the fluidic actuator layer in the fully inflated state to a fully deflated volume of the fluidic pressurization chamber when the fluidic actuator layer in the fully deflated state is at least 2:1.

7. The fluidic actuator of claim 1, wherein:
for each one of the fluidic actuator layers, a ratio of a fully inflated width of the fluidic actuator layer along the transverse axis when the fluidic actuator layer is in the fully inflated state to a fully deflated width of the fluidic actuator layer along the transverse axis when the fluidic actuator layer is in the fully deflated state is at most 1:2.

8. The fluidic actuator of claim 1, wherein:
for each one of the fluidic actuator layers, a ratio of a fully deflated height of the fluidic actuator layer along the expansion axis to a fully deflated width of the fluidic actuator layer along the transverse axis when the fluidic actuator layer is in the fully deflated state is at most 1:25,000.

9. The fluidic actuator of claim 1, wherein:
respective fluid inlets of adjacent pairs of the plurality of fluidic actuator layers provide fluidic access between the respectively corresponding sealed fluidic pressurization chambers.

10. The fluidic actuator of claim 1, wherein:
the inner fluid inlet of the end fluidic actuator layer provides fluidic access between the sealed fluidic pressurization chamber of the end fluidic actuator layer and the sealed fluidic pressurization chamber of an adjacent one of the fluidic actuator layers.

11. The fluidic actuator of claim 1, wherein:
abutting walls of adjacent pairs of the fluidic actuator layers are bonded together less than an entire width along the transverse axis of the corresponding fluidic actuator layers so as to form gaps between the respective peripheries of the corresponding fluidic actuator layers; and
a ratio of a fully inflated gap between the respective peripheries of the corresponding fluidic actuator layers when in the fully inflated state to a fully deflated gap between the respective peripheries of the corresponding fluidic actuator layers when in the fully deflated state is at least 10:1.

12. The fluidic actuator of claim 1, wherein:
at least two of the plurality of the fluidic actuator layers are pivoting fluidic actuator layers;
a pivot is hingedly or bendingly coupled to the pivoting actuator layers; and
inflation or deflation of at least one of the fluidic actuator layers causes relative rotation between at least some of the fluidic actuator layers about the pivot.

13. The fluidic actuator of claim 12, wherein:
the pivot is at respective pivot ends at the peripheries of the pivoting fluidic actuator layers hingedly or bendingly connected at the respective pivot ends.

14. The fluidic actuator of claim 12, wherein:
each of the pivoting fluidic actuator layers is connected to a corresponding tether; and
the tethers are connected at the pivot.

15. (canceled)

16. The fluidic actuator of claim 12, wherein:
the pivot is a hinge or a ball joint.

17. The fluidic actuator of claim 12, further comprising:
a linkage structure comprising:
for each of the pivoting fluidic actuator layers, a pivot flap connected at an actuator end thereof to the periphery of the corresponding pivoting fluidic actuator layer;
wherein:
the pivot is at hingedly or bendingly connected pivot ends of the respective pivot flaps of the pivoting fluidic actuator layers.

18. (canceled)

19. The fluidic actuator of claim 17, wherein a ratio of a common length of the pivot flaps to a common fully deflated width of the pivoting fluidic actuator layers when in a fully deflated state is at least 1:10.

20. The fluidic actuator of claim 1, wherein the walls of the fluidic actuator layers are circular.

21. The fluidic actuator of claim 1, wherein the walls of the fluidic actuator layers are lens-shaped.

22. The fluidic actuator of claim 1, wherein a cross-section of a fluidic actuator layer in a plane coincident with the expansion axis is lens-shaped.

23-46. (canceled)
